(19) United States
(12) Patent Application Publication
(10) Pub. No.: US 2026/0154606 A1
(43) Pub. Date: Jun. 4, 2026

(54) ACCELERATOR KERNEL AUTOTUNER FOR SPARSE HYPERPARAMETER SPACES

(71) Applicant: Microsoft Technology Licensing, LLC, Redmond, WA (US)

(72) Inventor: Ritwik DAS, Redmond, WA (US)

(73) Assignee: Microsoft Technology Licensing, LLC, Redmond, WA (US)

(21) Appl. No.: 18/964,197

(22) Filed: Nov. 29, 2024

(51) Int. Cl. G06N 20/00

(52) U.S. Cl. CPC G06N 20/00

(57) ABSTRACT

Effective kernel hyperparameters can be determined by an autotuner configured explore the entire hyperparameter space. A main process of the autotuner divides the hyperparameter space into batches, while worker processes determine batch-leading hyperparameter combinations for the batches along with a performance metrics for each batch-leading hyperparameter combination. The batch-leading hyperparameter combination for a given batch can be determined using an optimization tool which receives performance metrics for an initial sample set of valid hyperparameter combinations of the given batch and applies an optimization technique to select additional hyperparameter combinations of the given batch for evaluation. The number of hyperparameter combinations in the initial sample set and the number of additional hyperparameters to select for evaluation can be input as tuning settings of the autotuner. The main process receives the batch-leading hyperparameter combinations for the batches and compares their performance metrics to determine an overall-leading hyperparameter combination for the kernel.

### BACKGROUND

Hyperparameter tuning is a critical process in machine learning that involves setting the configuration parameters of algorithms, commonly referred to as hyperparameters, to improve model performance. Traditional methods like grid search and random search have been widely used but can be inefficient for complex models with large hyperparameter spaces. More recently, Bayesian optimization techniques have been used to intelligently prune the search space. However, these techniques have shortcomings when applied to accelerator kernels such as Graphics Processing Unit (GPU) kernels. For example, not all hyperparameter combinations are valid or useful; some require more shared memory than is available, some may violate the maximum grid dimension supported by the accelerator, etc.

Further, the hyperparameter space for an accelerator kernel is often very sparse (i.e., the majority of the datapoints in the hyperparameter space are invalid). However, existing hyperparameter tuning methods are not well-suited for sparse hyperparameter spaces. For example, because these methods often assume a relatively uniform distribution of valid configurations across the search space, they may waste time evaluating invalid or poor configurations when applied to a sparse hyperparameter space.

One existing iterative approach for tuning hyperparameters of machine learning models begins by selecting a small set of initial hyperparameter values. The selected hyperparameter values are then iteratively refined until convergence is achieved. However, this approach can suffer from several drawbacks. For example, because it starts with a small set of initial hyperparameter values, rather than searching the entire hyperparameter space, large areas of the hyperparameter space may be left unexplored. As a result, there is a higher chance that the most effective hyperparameter combination will not be found, especially in a sparse hyperparameter space where a majority of possible hyperparameter combinations are invalid.

### SUMMARY

In summary, the detailed description presents innovations in fast tuning a large sparse hyperparameter space for an accelerator kernel. An autotuner can perform autotuning of kernel hyperparameters by dividing a set of hyperparameter combinations for a kernel into a plurality of batches, each of which includes a disjoint subset of the set of hyperparameter combinations. Respective batch-leading hyperparameter combinations for the batches and respective performance metrics for the batch-leading hyperparameter combinations can be determined by worker processes implemented on respective accelerators of the autotuner. The worker processes can process batches in parallel, and each worker process can process batches sequentially as part of a job queue.

Determining a batch-leading hyperparameter combination for a given batch can include evaluating a first plurality of hyperparameter combinations from the given batch (e.g., an initial sample set) to generate respective performance metrics for the first plurality of hyperparameter combinations. The initial sample set can include randomly selected valid hyperparameter combinations; a number of hyperparameter combinations in the initial sample set can be determined based on a corresponding tuning setting input to the autotuner. An optimization technique can then be applied to select a second plurality of hyperparameter combinations from the given batch, which in turn can be evaluated to generate respective performance metrics for the second plurality of hyperparameter combinations. The batch-leading hyperparameter combination for the given batch can be determined from among the first plurality of hyperparameter combinations and the second plurality of hyperparameter combinations based on the respective performance metrics for the first plurality of hyperparameter combinations and the second plurality of hyperparameter combinations.

For example, determining the batch-leading hyperparameter combination for the given batch can include determining a subset of valid hyperparameter combinations from among the second plurality of hyperparameter combinations, and then comparing the respective performance metrics for the subset of valid hyperparameter combinations and the first plurality of hyperparameter combinations. A most effective hyperparameter combination from among the subset of valid hyperparameter combinations and the first plurality of hyperparameter combinations can be determined based on the comparison; the most effective hyperparameter combination can be understood as the hyperparameter combination that provides a best kernel performance among the hyperparameter combinations of the subset of valid hyperparameter combinations and the first plurality of hyperparameter combinations. The most effective hyperparameter combination can be designated as the batch-leading hyperparameter combination for the given batch.

In some examples, after the evaluation of the first plurality of hyperparameter combinations, the respective performance metrics for the first plurality of hyperparameter combinations can be compared to determine a most effective hyperparameter combination from among the first plurality of hyperparameter combinations (e.g., the hyperparameter combination which provide the best kernel performance according to one or more estimated or measured criteria such as the performance metrics). The most effective hyperparameter combination from among the first plurality of hyperparameter combinations can be designated as a current (e.g., tentative) batch-leading hyperparameter combination for the batch. During the subsequent evaluation of the second plurality of hyperparameter combinations, the respective performance metrics for the second plurality of hyperparameter combinations can be compared to the current batch-leading hyperparameter combination. If the comparison of the performance metrics for a given hyperparameter combination of the second plurality of hyperparameter combinations to the performance metrics for the current batch-leading hyperparameter combination indicates that the given hyperparameter combination is more effective (e.g., has a better performance) than the current batch-leading hyperparameter combination, and if the given hyperparameter combination is determined to be valid, the given hyperparameter combination is designated as the current batch-leading hyperparameter combination. Accordingly, after the second plurality of hyperparameter combinations have all been evaluated, the current batch-leading hyperparameter combination should be the most effective valid hyperparameter combination among the first plurality and second plurality of hyperparameter combinations, and thus can be designated as the batch-leading hyperparameter combination for the given batch.

Alternatively, the most effective hyperparameter combination of the second plurality of hyperparameter combinations can be determined independently and then compared with the most effective hyperparameter combination of the first plurality of hyperparameter combinations to determine the batch-leading hyperparameter combination for the given batch.

The respective performance metrics for the batch-leading hyperparameter combinations can then be compared to determine an overall-leading hyperparameter combination from among the batch-leading hyperparameter combinations for the batches. For example, determining the overall-leading hyperparameter combination can include comparing the respective performance metrics for the batch-leading hyperparameter combinations and determining a most effective hyperparameter combination from among the batch-leading hyperparameter combinations based on the comparison; the most effective hyperparameter combination can refer to the batch-leading hyperparameter combination that provides a best kernel performance among the batch-leading hyperparameter combinations. The most effective hyperparameter combination can be designated as the overall-leading hyperparameter combination. The overall-leading hyperparameter combination can be output and subsequently used to configure the kernel at runtime (e.g., when the kernel is deployed as part of a machine learning model).

The innovations described herein can be implemented as part of a method, as part of a computer system (physical or virtual, as described below) configured to perform the method, or as part of a tangible computer-readable media storing computer-executable instructions for causing one or more processors, when programmed thereby, to perform the method. The various innovations can be used in combination or separately. The innovations described herein include the innovations covered by the claims. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures and illustrates a number of examples. Examples may also be capable of other and different applications, and some details may be modified in various respects all without departing from the spirit and scope of the disclosed innovations.

### BRIEF DESCRIPTION OF THE DRAWINGS

The following drawings illustrate some features of the disclosed innovations.

FIG. 1 is a graph illustrating an example large sparse hyperparameter space.

FIG. 2 is a diagram illustrating an example computer system in which some described embodiments can be implemented.

FIG. 3 is a diagram of an example network environment in which some described embodiments can be implemented.

FIG. 4 is a diagram illustrating an example overview of a workflow for an accelerator kernel autotuner.

FIG. 5 is a diagram of an example main process for an accelerator kernel autotuner.

FIG. 6 is a diagram of an example batch processing technique for an accelerator kernel autotuner.

FIG. 7 is a diagram of an example worker process for an accelerator kernel autotuner.

FIG. 8 is a flowchart illustrating a generalized technique for autotuning a kernel.

FIG. 9 is a graph illustrating example variance of achieved throughput with different values for the known trials setting and a fixed value for the unknown trials setting.

FIG. 10 is a graph illustrating example variance of tuning time with different values for the known trials for the known trials parameter and a fixed value for the unknown trials setting.

FIG. 11 is a graph illustrating example variance of achieved throughput with different values for the unknown trials setting and a fixed value for the known trials setting.

FIG. 12 is a graph illustrating example variance of tuning time with different values for the unknown trials setting and a fixed value for the known trials setting.

### DETAILED DESCRIPTION

The detailed description presents innovations in fast tuning of a large sparse hyperparameter space for an accelerator kernel. These innovations can provide an automated solution for tuning accelerator kernels which programmatically explores the entire hyperparameter space to find an effective hyperparameter combination for the accelerator kernel.

The technologies described herein provide technical solutions to the technical problems associated with tuning large sparse hyperparameter spaces. One such technical problem involves the combinatorial explosion of hyperparameter spaces due to growing numbers of hyperparameters, and more, importantly the sparsity of such hyperparameter spaces. As discussed above, existing hyperparameter tuning methods tend to be ineffective for sparse hyperparameter spaces. Another technical problem involves the high amount of manual effort currently required to tune kernel hyperparameters, which is costly and can slow down deployments.

Technical solutions provided by the technologies disclosed herein include an autotuner for automatically tuning kernels which divides the entire hyperparameter space for a given kernel into batches. In accordance with the technologies disclosed herein, optimization techniques and parallel processing are employed to quickly identify a batch-leading hyperparameter combination for each batch, and the most effective batch-leading hyperparameter combination (e.g., the batch-leading hyperparameter combination which provides the best kernel performance according to one or more estimated or measured criteria such as the performance metrics described herein) is designated as the overall-leading hyperparameter combination for the kernel. Accordingly, the technologies disclosed herein provide technical advantages, such as reducing manual effort needed to tune a kernel and expediting the tuning process.

In accordance with the technologies disclosed herein, the autotuner splits the hyperparameter combinations of the hyperparameter space into batches. The batches are dispatched to respective accelerators of the autotuner for parallel processing by the accelerators, which advantageously speeds up the overall tuning process. As an additional technical advantage, dispatching batches to accelerators for parallel processing can also improve the efficiency of the processors of the autotuner which build the kernel code. When a larger batch size is used, the load on a given processor is typically increased relative to the load on the processor for a smaller batch size (with more switching between jobs). Accordingly, splitting the hyperparameter combinations of the hyperparameter space into batches helps to ensure effective usage of the processors and avoid processing bottlenecks.

Additional technical advantages provided by the technologies disclosed herein include improved kernel performance for kernels tuned by the autotuner. Experimental results for the autotuner have demonstrated significant improvements in peak throughput and runtime, including a peak throughput improvement of ˜40% and an average speedup of 145% for a Half-Precision General Matrix Multiply (HGEMM) kernel.

In the examples described herein, identical reference numbers in different figures indicate an identical component, module, or operation. More generally, various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Some of the innovations described herein address one or more of the problems noted in the background. Typically, a given technique/tool does not solve all such problems. It is to be understood that other examples may be utilized and that structural, logical, software, hardware, and electrical changes may be made without departing from the scope of the disclosure. The following description is, therefore, not to be taken in a limited sense.

### I. Example Large Sparse Hyperparameter Space.

The explorable hyperparameter space for accelerator kernels can often be very large. However, due to incompatibility of hyperparameters with each other or with accelerator hardware, not all datapoints in the space are valid or useful for tuning. In fact, most of the space may be filled with invalid hyperparameter combinations, such that the space is only sparsely populated with valid or useful combinations.

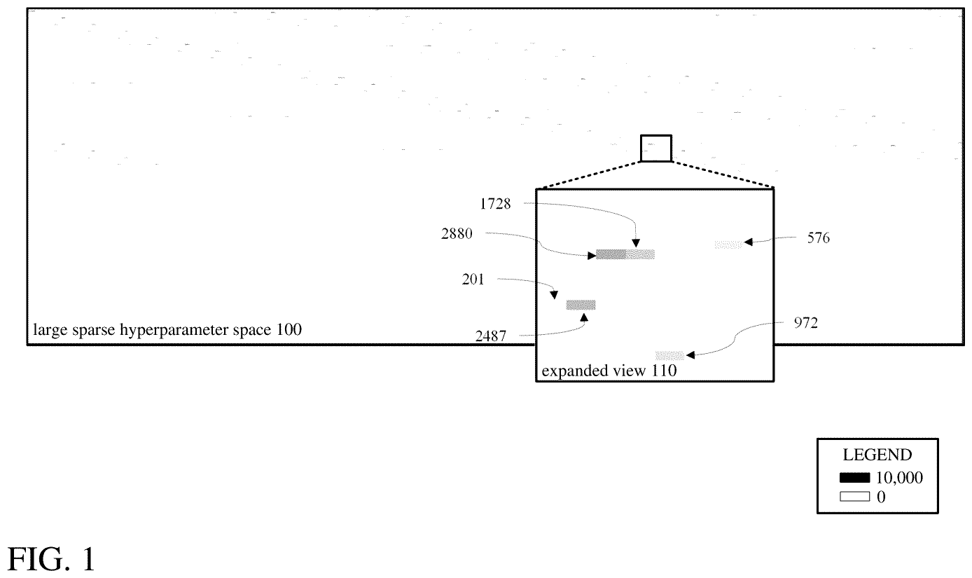

An example large sparse hyperparameter space (100) is shown in FIG. 1. In the depicted example, the hyperparameter space for a General Matrix Multiply (GEMM) kernel is visualized on a two-dimensional grid. Each cell of the grid represents 10,000 different hyperparameter combinations; the shade of a given cell represents how many of those are valid combinations or occupancy. As indicated by the legend, a white cell indicates that there are no valid combinations among the 10,000 combinations the cell represents, whereas a black cell indicates that all of the 10,000 combinations the cell represents are valid. In the example, the grid represents the entire explorable hyperparameter space which includes 629,145,600 different hyperparameter combinations. Among these combinations, the total number of valid testable combinations is only 422,820 (i.e., only approximately 0.067% of the entire space).

An expanded view (110) of a small slice of the grid and the corresponding occupancy of each non-empty cell is shown for the sake of clarity. While most of the cells in the expanded view (110) are white cells with no valid combinations, six of the cells do include valid combinations. As indicated, the number of valid combinations in these six cells ranges from 201 to 2880.

It can be especially challenging to test the possible hyperparameter combinations for a given kernel due to the volume of the explorable hyperparameter space. For example, the hyperparameter space (100) includes nearly 500,000 valid hyperparameter combinations for a single input set, and there may be hundreds of inputs in a single workload. To address such challenges, techniques are described herein in which an autotuner is employed to efficiently and reasonably tune kernels even when the corresponding hyperparameter space is large and sparse.

### II. Example Computer Systems.

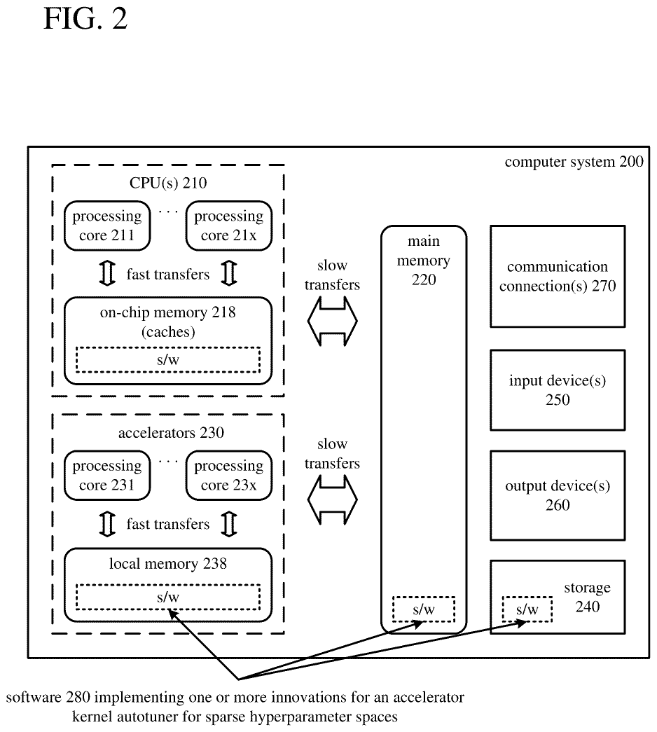

FIG. 2 illustrates a generalized example of a suitable computer system (200) in which several of the described innovations may be implemented. The innovations described herein relate to fast tuning of a large sparse hyperparameter space for an accelerator kernel. The computer system (200) is not intended to suggest any limitation as to scope of use or functionality, as the innovations may be implemented in diverse computer systems, including special-purpose computer systems.

With reference to FIG. 2, the computer system (200) includes one or more processing cores (211 . . . 21x) and local memory (218) of a central processing unit (“CPU”) or multiple CPUs (210). The processing core(s) (211 . . . 21x) are, for example, processing cores on a single chip, and execute computer-executable instructions. The number of processing core(s) (211 . . . 21x) depends on implementation and can be, for example, 4 or 8. The local memory (218) may be volatile memory (e.g., registers, cache, random access memory (“RAM”)), non-volatile memory (e.g., read-only memory (“ROM”), electrically erasable programmable ROM (“EEPROM”), flash memory), or some combination of the two, accessible by the respective processing core(s) (211 . . . 21x). Alternatively, the processing cores (211 . . . 21x) can be part of a system-on-a-chip (“SoC”), application-specific integrated circuit (“ASIC”), or other integrated circuit.

The local memory (218) can store software (280) implementing aspects of the innovations for fast tuning of a large sparse hyperparameter space for an accelerator kernel, for operations performed by the respective processing core(s) (211 . . . 21x), in the form of computer-executable instructions. In FIG. 2, the local memory (218) is on-chip memory such as one or more caches, for which access operations, transfer operations, etc. with the processing core(s) (211 . . . 21x) are fast.

The computer system (200) also includes processing cores (231 . . . 23x) and local memory (238) for each of a plurality of hardware accelerators (230). Accelerators (230) can include, for example, a graphics processing unit (“GPU”) or multiple GPUs, a tensor processor unit (“TPU”) or multiple TPUs, a field-programmable gate array (“FPGA”) or multiple FPGAs, an application-specific integrated circuit (“ASIC”) or multiple ASICs, a neural processing unit (“NPU”) or multiple NPUs, one or more systolic arrays, and/or one or more vector processors. Such accelerator(s) may alternatively be referred to as artificial intelligence (AI) accelerators. In some examples, the accelerators (230) are all implemented by the same type of accelerator (e.g., all the accelerators are GPUs); in other examples, two or more different types of accelerators may be included in accelerators (230).

The number of processing cores (231 . . . 23x) of a given one of the accelerators (230) depends on implementation. In some examples, the processing cores (231 . . . 23x) are part of single-instruction, multiple data (“SIMD”) units of the accelerator. The SIMD width n, which depends on implementation, indicates the number of elements (sometimes called lanes) of a SIMD unit. For example, the number of elements (lanes) of a SIMD unit can be 16, 32, 64, or 128 for an extra-wide SIMD architecture. The local memory (238) of the respective accelerators (230) may be volatile memory (e.g., registers, cache, RAM), non-volatile memory (e.g., ROM, EEPROM, flash memory), or some combination of the two, accessible by the respective processing cores (231 . . . 23x). The local memory (238) can store software (280) implementing aspects of the innovations for fast tuning of a large sparse hyperparameter space for an accelerator kernel, for operations performed by the respective processing cores (231 . . . 23x), in the form of computer-executable instructions such as shader code.

The computer system (200) includes main memory (220), which may be volatile memory (e.g., RAM), non-volatile memory (e.g., ROM, EEPROM, flash memory), or some combination of the two, accessible by the processing core(s) (211 . . . 21x, 231 . . . 23x). The main memory (220) stores software (280) implementing aspects of the innovations for fast tuning of a large sparse hyperparameter space for an accelerator kernel, in the form of computer-executable instructions. In FIG. 2, the main memory (220) is off-chip memory, for which access operations, transfer operations, etc. with the processing cores (211 . . . 21x, 231 . . . 23x) are slower.

More generally, the term “processor” refers generically to any device that can process computer-executable instructions and may include a microprocessor, microcontroller, programmable logic device, digital signal processor, and/or other computational device. A processor may be a processing core of a CPU, other general-purpose unit, or GPU. A processor may also be a specific-purpose processor implemented using, for example, an ASIC or an FPGA. A “processing system” is a set of one or more processors, which can be located together or distributed across a network.

The term “control logic” refers to a controller or, more generally, one or more processors, operable to process computer-executable instructions, determine outcomes, and generate outputs. Depending on implementation, control logic can be implemented by software executable on a CPU, by software controlling special-purpose hardware (e.g., an accelerator), or by special-purpose hardware.

A computer system may have additional features. For example, the computer system (200) includes storage (240), one or more input devices (250), one or more output devices (260), and one or more communication connections (270). An interconnection mechanism (not shown) such as a bus, controller, or network interconnects the components of the computer system (200). Typically, operating system (“OS”) software (not shown) provides an operating environment for other software executing in the computer system (200), and coordinates activities of the components of the computer system (200).

The tangible storage (240) may be removable or non-removable, and includes magnetic storage media such as magnetic disks, magnetic tapes or cassettes, optical storage media such as CD-ROMs or DVDs, or any other medium which can be used to store information and which can be accessed within the computer system (200). The storage (240) can store instructions for the software (280) implementing one or more innovations for fast tuning of a large sparse hyperparameter space for an accelerator kernel.

The input device(s) (250) may be a touch input device such as a keyboard, mouse, pen, or trackball, a voice input device, a scanning device, or another device that provides input to the computer system (200). For video, the input device(s) (250) may be a camera, video card, screen capture module, TV tuner card, or similar device that accepts video input in analog or digital form, or a CD-ROM or CD-RW that reads video input into the computer system (200). The output device(s) (260) may be a display, printer, speaker, CD-writer, or another device that provides output from the computer system (200).

The communication connection(s) (270) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, communication media can use an electrical, optical, RF, or other carrier.

The computer system (200) of FIG. 2 is a physical computer system. A virtual machine can include components organized as shown in FIG. 2.

The term “application” or “program” refers to software such as any user-mode instructions to provide functionality. The software of the application (or program) can further include instructions for an operating system and/or device drivers. The software can be stored in associated memory. The software may be, for example, firmware. While it is contemplated that an appropriately programmed general-purpose computer or computing device may be used to execute such software, it is also contemplated that hard-wired circuitry or custom hardware (e.g., an ASIC) may be used in place of, or in combination with, software instructions. Thus, examples described herein are not limited to any specific combination of hardware and software.

The term “computer-readable medium” refers to any medium that participates in providing data (e.g., instructions) that may be read by a processor and accessed within a computing environment. A computer-readable medium may take many forms, including non-volatile media and volatile media. Non-volatile media include, for example, optical or magnetic disks and other persistent memory. Volatile media include dynamic random access memory (“DRAM”). Common forms of computer-readable media include, for example, a solid state drive, a flash drive, a hard disk, any other magnetic medium, a CD-ROM, DVD, any other optical medium, RAM, programmable read-only memory (“PROM”), erasable programmable read-only memory (“EPROM”), a USB memory stick, any other memory chip or cartridge, or any other medium from which a computer can read. The term “non-transitory computer-readable media” specifically excludes transitory propagating signals, carrier waves, and wave forms or other intangible or transitory media that may nevertheless be readable by a computer. The term “carrier wave” may refer to an electromagnetic wave modulated in amplitude or frequency to convey a signal.

The innovations can be described in the general context of computer-executable instructions being executed in a computer system on a target real or virtual processor. The computer-executable instructions can include instructions executable on processing cores of a general-purpose processor to provide functionality described herein, instructions executable to control an accelerator to provide functionality described herein, and/or instructions executable on processing cores of an accelerator to provide functionality described herein. In some implementations, computer-executable instructions can be organized in program modules. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computer system.

The terms “system” and “device” are used interchangeably herein. Unless the context clearly indicates otherwise, neither term implies any limitation on a type of computer system or device. In general, a computer system or device can be local or distributed, and can include any combination of special-purpose hardware and/or hardware with software implementing the functionality described herein.

Numerous examples are described in this disclosure, and are presented for illustrative purposes only. The described examples are not, and are not intended to be, limiting in any sense. The presently disclosed innovations are widely applicable to numerous contexts, as is readily apparent from the disclosure. One of ordinary skill in the art will recognize that the disclosed innovations may be practiced with various modifications and alterations, such as structural, logical, software, and electrical modifications. Although particular features of the disclosed innovations may be described with reference to one or more particular examples, it should be understood that such features are not limited to usage in the one or more particular examples with reference to which they are described, unless expressly specified otherwise. The present disclosure is neither a literal description of all examples nor a listing of features of the invention that must be present in all examples.

When an ordinal number (such as “first,” “second,” “third” and so on) is used as an adjective before a term, that ordinal number is used (unless expressly specified otherwise) merely to indicate a particular feature, such as to distinguish that particular feature from another feature that is described by the same term or by a similar term. The mere usage of the ordinal numbers “first,” “second,” “third,” and so on does not indicate any physical order or location, any ordering in time, or any ranking in importance, quality, or otherwise. In addition, the mere usage of ordinal numbers does not define a numerical limit to the features identified with the ordinal numbers.

When introducing elements, the articles “a,” “an,” “the,” and “said” are intended to mean that there are one or more of the elements. The terms “comprising,” including,” and “having” are intended to be inclusive and mean that there may be additional elements other than the listed elements.

When a single device, component, module, or structure is described, multiple devices, components, modules, or structures (whether or not they cooperate) may instead be used in place of the single device, component, module, or structure. Functionality that is described as being possessed by a single device may instead be possessed by multiple devices, whether or not they cooperate. Similarly, where multiple devices, components, modules, or structures are described herein, whether or not they cooperate, a single device, component, module, or structure may instead be used in place of the multiple devices, components, modules, or structures. Functionality that is described as being possessed by multiple devices may instead be possessed by a single device. In general, a computer system or device can be local or distributed, and can include any combination of special-purpose hardware and/or hardware with software implementing the functionality described herein.

Further, the techniques and tools described herein are not limited to the specific examples described herein. Rather, the respective techniques and tools may be utilized independently and separately from other techniques and tools described herein.

Device, components, modules, or structures that are in communication with each other need not be in continuous communication with each other, unless expressly specified otherwise. On the contrary, such devices, components, modules, or structures need only transmit to each other as necessary or desirable, and may actually refrain from exchanging data most of the time. For example, a device in communication with another device via the Internet might not transmit data to the other device for weeks at a time. In addition, devices, components, modules, or structures that are in communication with each other may communicate directly or indirectly through one or more intermediaries.

As used herein, the term “send” denotes any way of conveying information from one device, component, module, or structure to another device, component, module, or structure. The term “receive” denotes any way of getting information at one device, component, module, or structure from another device, component, module, or structure. The devices, components, modules, or structures can be part of the same computer system or different computer systems. Information can be passed by value (e.g., as a parameter of a message or function call) or passed by reference (e.g., in a buffer). Depending on context, information can be communicated directly or be conveyed through one or more intermediate devices, components, modules, or structures. As used herein, the term “connected” denotes an operable communication link between devices, components, modules, or structures, which can be part of the same computer system or different computer systems. The operable communication link can be a wired or wireless network connection, which can be direct or pass through one or more intermediaries (e.g., of a network).

A description of an example with several features does not imply that all or even any of such features are required. On the contrary, a variety of optional features are described to illustrate the wide variety of possible examples of the innovations described herein. Unless otherwise specified explicitly, no feature is essential or required.

Further, although process steps and stages may be described in a sequential order, such processes may be configured to work in different orders. Description of a specific sequence or order does not necessarily indicate a requirement that the steps or stages be performed in that order. Steps or stages may be performed in any order practical. Further, some steps or stages may be performed simultaneously despite being described or implied as occurring non-simultaneously. Description of a process as including multiple steps or stages does not imply that all, or even any, of the steps or stages are essential or required. Various other examples may omit some or all of the described steps or stages. Unless otherwise specified explicitly, no step or stage is essential or required. Similarly, although a product may be described as including multiple aspects, qualities, or characteristics, that does not mean that all of them are essential or required. Various other examples may omit some or all of the aspects, qualities, or characteristics.

An enumerated list of items does not imply that any or all of the items are mutually exclusive, unless expressly specified otherwise. Likewise, an enumerated list of items does not imply that any or all of the items are comprehensive of any category, unless expressly specified otherwise.

For the sake of presentation, the detailed description uses terms like “determine” and “select” to describe computer operations in a computer system. These terms denote operations performed by one or more processors or other components in the computer system, and should not be confused with acts performed by a human being. The actual computer operations corresponding to these terms vary depending on implementation.

### III. Example Network Environments.

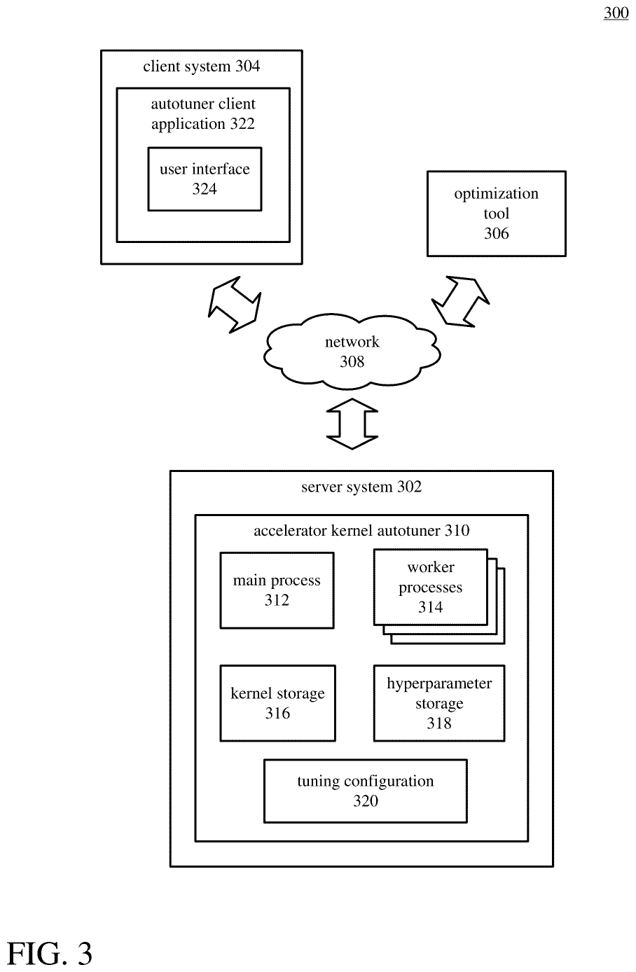

FIG. 3 shows an example network environment (300) that includes a server system (302), a client system (304), and an optimization tool (306). The server system (302), client system (304), and optimization tool (306) connect over a network (308) such as the Internet or another computer network.

The server system (302) can be distributed among multiple computer systems, or alternatively, implemented by a single computer system. In the example, the server system (302) includes an accelerator kernel autotuner (310), which is referred to as autotuner (310) herein for the sake of brevity. The autotuner (310) is a multi-process tool which includes a main process (312), a plurality of worker processes (314), a kernel storage (316), a hyperparameter storage (318), and a tuning configuration (320). In some examples, the autotuner (310) is implemented by a multiprocessing module in a programming language such as Python.

As described further herein, the main process (312) is configured to interact with and employ one or more CPUs (e.g., CPU(s) (210) of FIG. 2) and a plurality of hardware accelerators (e.g., accelerators (230) of FIG. 2) to perform operations for fast tuning of a large sparse hyperparameter space for an accelerator kernel. Towards this end, the main process (312) delegates jobs to the worker processes (314) which are carried out on respective accelerators of the plurality of accelerators.

The kernel storage (316) can include computer-readable storage media which stores accelerator kernels. An accelerator kernel can refer to a specialized piece of code designed to run on hardware accelerators such as GPUs, TPUs, FPGAs, and the like. In some examples, the code for a given accelerator kernel is written in a programming language such as C++ or in accordance with a programming model such as Compute Unified Device Architecture (CUDA). The respective accelerator kernels can be stored in the kernel storage (316) as individual files, or in another manner.

The hyperparameter storage (318) can include computer-readable storage media which stores values of hyperparameters (e.g., hyperparameters associated with accelerator kernels stored in kernel storage (316)). Some examples of hyperparameters for accelerator kernels include tile dimension, warp dimension, number of stages, number of blocks, and block size.

Alternatively, the kernel storage (316) and/or the hyperparameter storage (318) can be implemented separately from the autotuner (310). For example, kernels and/or hyperparameter values may be stored on one or more other server systems, such as by a third-party storage service.

The tuning configuration (320) can include computer-readable storage media which stores settings associated with the operations performed by the autotuner (310), referred to herein as tuning settings. The tuning settings stored in the tuning configuration (320) may be received from the client system (304), as described further below. Alternatively, the autotuner (310) may be configured to select appropriate tuning settings for a given accelerator kernel, e.g., based on characteristics of the kernel or other factors.

The client system (304) is configured to execute an autotuner client application (322), which includes a user interface (UI) (324). In some examples, the autotuner client application (322) is configured to receive user input via the UI (324) such as a request to initiate an autotuning session for a specified accelerator kernel via the autotuner (310). The user input can also include tuning settings for the autotuning session; for example, the UI (324) can be configured to display various tuning settings and receive user input selecting one or more tuning settings and/or specifying desired settings or values for respective tuning settings.

The client system (304) can include any suitable computing device capable of executing the autotuner client application (322) (e.g., a desktop computer, a laptop computer, a tablet computer, or a smartphone). Although a single client system (304) is shown, the network environment (300) can include multiple client systems (304) which run respective instances of the autotuner client application (322).

The autotuner (310) can also include other components, such as server-side controller logic for managing connections with the autotuner client application (322) of the client system (304). Similarly, the autotuner client application (322) can also include other components, such as client-side controller logic for managing connections with the autotuner (310).

The optimization tool (306) can include software executable in a computing system to determine which hyperparameter combination among a plurality of hyperparameter combinations in a given batch is the most effective (referred to herein as the batch-leading hyperparameter combination for the given batch). In particular, a given one of the worker processes (314) can invoke the optimization tool (306) during processing of the given batch of hyperparameter combinations to determine the batch-leading hyperparameter combination for the given batch, as described further herein. Towards this end, the optimization tool (306) can be configured to utilize one or more optimization techniques to efficiently search for effective hyperparameter configurations (e.g., the hyperparameter configurations which provide the best kernel performance according to one or more estimated or measured criteria such as the performance metrics described herein). Example optimization techniques that may be employed by the optimization tool include Bayesian optimization, grid search, random sampling, Monte Carlo sampling, and brute force search. Towards this end, the optimization tool (306) may include a library of available optimization functions.

In some example implementations, the optimization tool (306) utilizes Optuna, an open-source Python library for hyperparameter optimization in machine learning. Alternatively, the optimization tool (306) can be implemented in some other way (e.g., using other Python libraries such as Ray Tune, HyperOpt, or Scikit-Optimize).

Although the optimization tool (306) is shown separately, the optimization tool (306) can alternatively be incorporated in the autotuner (310). For example, the optimization tool (306) can be implemented as a software module of the autotuner (310) or in another manner.

### IV. Example Overview of Autotuner Workflow.

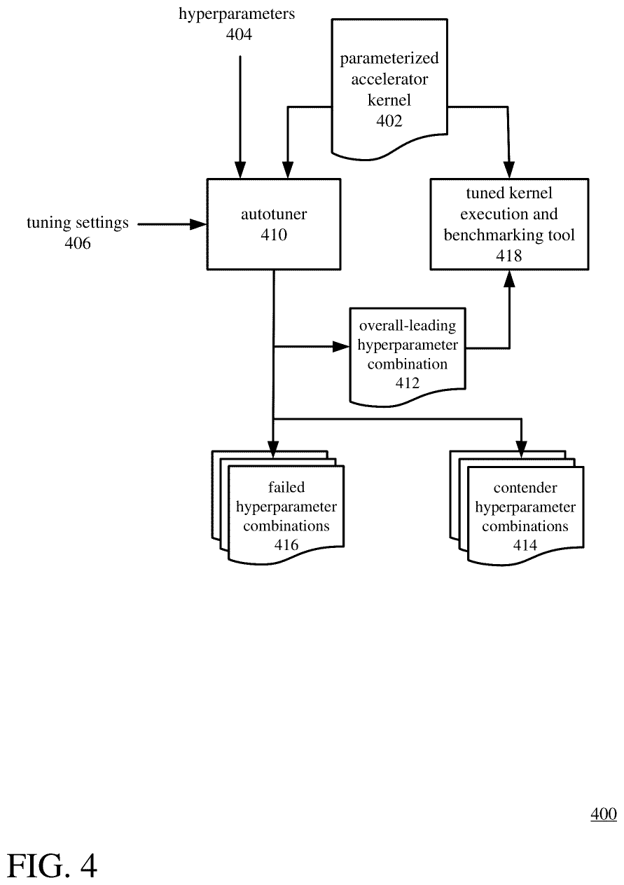

FIG. 4 shows an example overview (400) of a workflow for an accelerator kernel autotuner (410), which corresponds to autotuner (310) of FIG. 3.

As shown, the autotuner (410) receives a parameterized accelerator kernel (402), hyperparameters (404) associated with the parameterized accelerator kernel (402), and tuning settings (406) as inputs. The inputs may be provided to the autotuner (410) via user input to a UI of an autotuner client application such as autotuner client application (322) of FIG. 3, or in another manner. For example, the user input can include user selection of a file path for the parameterized accelerator kernel (402) and/or a file path for the hyperparameters (404), along with user selection of and/or specification of values for the tuning settings (406).

The parameterized accelerator kernel (402) is an accelerator kernel designed with parameters that can be adjusted to improve performance for different hardware configurations or workloads. These adjustable parameters are not hyperparameters, but rather specific configuration settings or arguments that control how the kernel operates on an accelerator (e.g., kernel arguments, execution configuration parameters, resource allocation parameters, etc.)

The tuning settings (406) can include settings associated with the operations performed by the autotuner (410). The tuning settings (406) may be input by a user of an autotuner client application (e.g., autotuner client application (322) of FIG. 3), and/or the autotuner (410) may select appropriate tuning settings for the parameterized accelerator kernel (402).

In some examples, the autotuner (410) may be configured to autotune the parameterized accelerator kernel (402) without receiving any tuning settings (406). In such examples, the autotuner (410) may instead use default settings for the tuning settings and/or determine appropriate tuning settings based on various factors.

After receiving the parameterized accelerator kernel (402), the hyperparameters (404), and optionally, the tuning settings (406), the autotuner performs a main process in which a hyperparameter space made up of combinations of the hyperparameters (404) is generated and the hyperparameter combinations are delegated in batches to respective worker processes. Each worker process determines and reports a batch-leading hyperparameter combination and corresponding statistics for each batch. The statistics for a batch-leading hyperparameter combination of a given batch can include one or more performance metrics for a kernel configured with the batch-leading hyperparameter combination (e.g., kernel runtime, floating-point operations per second during execution of the kernel, and/or kernel throughput).

After all the batches have been processed, the main process collects the statistics from each batch to calculate an overall-leading hyperparameter combination (412) and one or more contender hyperparameter combinations (414) from among the batch-leading hyperparameter combinations and then outputs the result (e.g., writes the result to an output file). For example, determining the overall-leading hyperparameter combination can include comparing respective performance metrics for the batch-leading hyperparameter combinations and determining a most effective hyperparameter combination from among the batch-leading hyperparameter combinations based on the comparison. The most effective hyperparameter combination can be designated as the overall-leading hyperparameter combination.

The contender hyperparameter combinations can include hyperparameter combinations with a performance metric within a predefined threshold of a performance metric of the overall-leading hyperparameter combination. The predefined threshold for the contender hyperparameter combinations can be specified as one of the tuning settings (406) (e.g., as a contender variance tuning setting).

Optionally, the main process can also output the remaining batch-leading hyperparameter combinations for the batches, referred to as failed hyperparameter combinations (416) (e.g., as part of the result or in another manner).

In the example, the overall-leading hyperparameter combination (412) is output to a tuned kernel execution and benchmarking tool (418). The tool (418) can be configured receive a plurality of parameterized accelerator kernels (402) which collectively form a machine learning model, along with their respective overall-leading hyperparameter combinations (412) which were generated by the autotuner (410) during separate tuning sessions. The tool (418) can then instantiate the kernels with the respective overall-leading hyperparameter combinations to obtain tuned kernels and execute an end-to-end inference run including all of the tuned kernels. The tool (418) performs benchmarking to measure the performance of the end-to-end inference run (e.g., by measuring the runtime, floating-point operations per second, and/or throughput of the end-to-end inference run). Optionally, the tool (418) can first perform an end-to-end inference run with the original (untuned) kernels to provide a baseline for a performance comparison with the end-to-end inference run performed with the tuned kernels.

The result output by the autotuner (410) can be used by a workload at runtime to select hyperparameters for execution of the parameterized accelerator kernel (402). For example, in a production environment, the overall-leading hyperparameter combination for a given parameterized accelerator kernel can be retrieved (e.g., from a database that stores the output of the autotuner (410)). The parameterized accelerator kernel can then be instantiated with the overall-leading hyperparameter combination to achieve improved performance.

### V. Example Tuning Settings.

In some examples, an accelerator kernel autotuner may be configured using one or more of the following tuning settings, which may alternatively be referred to as tuning options. As described with reference to FIG. 3, the tuning settings can be collectively referred to as a tuning configuration for the autotuner. Optionally, the autotuner may have certain default tuning settings which can be modified for each parameterized accelerator kernel. Examples of possible tuning settings for an autotuner are provided in Table 1 below.

TABLE 1
Example Tuning Settings

| Tuning Setting | Description |
|---|---|
| continue session | The autotuner is a reentrant tool, meaning that it can be paused during a |
| | tuning session (e.g., as tuning can be a long-running process). In this |
| | case, partial results can be stored in the file system so that the tuning |
| | session can be resumed at a later time. Enabling the continue session |
| | setting allows tuning to be resumed at the stopping point of the previous |
| | session; without enabling this setting, the previously recorded tuning |
| | results are cleared and tuning starts from the first input. |
| maximum batch | During tuning, the autotuner splits up the datapoints of the entire |
| size | hyperparameter space (i.e., the hyperparameter combinations) into |
| | batches, which in turn are dispatched to the available accelerators of the |
| | autotuner for tuning. The value of the maximum batch size setting thus |
| | dictates the number of kernels in a single tuning batch. The value of the |
| | maximum batch size setting also affects CPU utilization; higher batch |
| | sizes usually imply higher CPU requirements since the kernel builds are |
| | issued concurrently across the available CPU cores for all kernels in a |
| | given batch. |
| input dataset | This setting receives the dataset that is to be tuned as an argument. For |
| | example, for a GEMM kernel, input datasets such as CoDEx, Deep Voice |
| | 3 (DV3), and Scallion may be specified. |
| kernel | This setting receives the kernel to be tuned as an argument. |
| save failures | This setting can be enabled to save failed hyperparameter combinations |
| | to a file. |
| set clocks | This setting can be used to set accelerator clocks (e.g., shader clocks) to a |
| | fixed frequency before starting the tuning session and reset the clocks |
| | once tuning is over. Without this setting, the autotuner does not modify |
| | any accelerator clocks. |
| multiple | This setting controls accelerator parallelism, e.g., whether a single |
| accelerator | parameterized kernel input can be tuned across different accelerators. In |
| | particular, enabling this setting enables multi-accelerator tuning. If there |
| | is significant variability in performance characteristics of the different |
| | accelerators of the server system implementing the autotuner, it may be |
| | preferable to disable this setting so that each input is instead tuned on a |
| | single accelerator rather than across several accelerators. |
| number of input | This setting controls the number of times each kernel is run before |
| sets | calculation of its mean performance. Each run is performed with a |
| | different input set that is randomly generated to minimize the effects of |
| | caching. Using higher values for this setting can increase confidence of |
| | the tuning outcome with the trade-off of a higher tuning overhead. |
| use graph | This setting can be enabled to launch kernels using a graph-based |
| | execution model such as Heterogeneous-compute Interface for |
| | Portability Graph (HIPGraph) or CUDAGraph. |
| contender variance | In addition to the overall-leading hyperparameter combination, the |
| | autotuner also outputs contender hyperparameter combinations (i.e., any |
| | batch-leading hyperparameter combinations with a performance metric |
| | within a predefined range of a corresponding performance metric of the |
| | overall-leading hyperparameter combination). The value of the |
| | contender variance setting dictates this range, and thus controls the |
| | variance of performance allowed for the contenders. For example, if the |
| | contender variance is set to 20%, hyperparameter combinations with a |
| | performance metric greater than or equal to 80% of a performance metric |
| | of the overall-leading hyperparameter combination will also be reported. |
| known trials | The known trials setting dictates the percentage of jobs per batch that |
| | will be measured by the autotuner and supplied to the optimization tool |
| | as an initial sample set. For example, if the maximum batch size setting |
| | is 200 and the known trials setting is 10%, the autotuner will measure |
| | 10% of 200 = 20 hyperparameter combinations per batch and use them as |
| | initial samples for further optimization. Similarly, a known trials setting |
| | of 100% would cause the autotuner to run all the hyperparameter |
| | combinations thus resulting in a brute force exploration of the |
| | hyperparameter space. (The hyperparameter combinations used for the |
| | initial sample set are known to be valid. Accordingly, setting a higher |
| | known trials value results in a better the tuning outcome but a higher |
| | tuning cost in terms of runtime.) |
| unknown trials | The unknown trials setting dictates the percentage of hyperparameter |
| | combinations per batch that will be sampled by the optimization tool in |
| | addition to the known trials. For example, if the maximum batch size |
| | setting is 200 and the unknown trials setting is 5%, the optimization tool |
| | will sample 5% of 200 = 10 hyperparameter combinations in addition to |
| | the initial sample set for optimization. The hyperparameter combinations |
| | chosen by the optimization tool for the unknown trials could potentially |
| | be invalid, in which case they will be ignored by the objective function. |
| | Accordingly, to run a minimum of M % and a maximum of N % of the |
| | hyperparameter combinations from a given batch, the corresponding |
| | values for the known trials and unknown trials settings should be M and |
| | N − M, respectively. Setting a higher unknown trials value results in a |
| | better tuning outcome but a higher tuning cost in terms of runtime. |
| prune hyperspace | When the prune hyperspace setting is enabled, the autotuner operates in a |
| | mode in which the entire explorable hyperparameter space is not |
| | traversed in order to tune an input. Instead, the leading hyperparameter |
| | combinations of the existing tuning results are analyzed to prune the |
| | hyperspace of the current input; this leads to a much tighter explorable |
| | space and thus a reduced tuning time. For example, if the leading |
| | hyperparameter combinations of all the relevant tuning results have a |
| | value of 2 or 3 for a split k hyperparameter, then the autotuner will only |
| | use these values for further tuning, thereby pruning all the other possible |
| | values of split k from the hyperparameter space. |

### VI. Example Main Process and Worker Processes.

The autotuner is designed to be a multi-process tool which maximizes efficiency via parallel processing of accelerator kernels across processor and accelerator devices. Towards this end, the autotuner follows a single producer-multiple consumers model where the producer (i.e., the main process) is responsible for submitting tuning jobs (batches) to job queues for consumers (i.e., worker processes), summarizing the partial tuning results from the consumers, and storing the final result to the file system (e.g., to kernel storage (316) of FIG. 3).

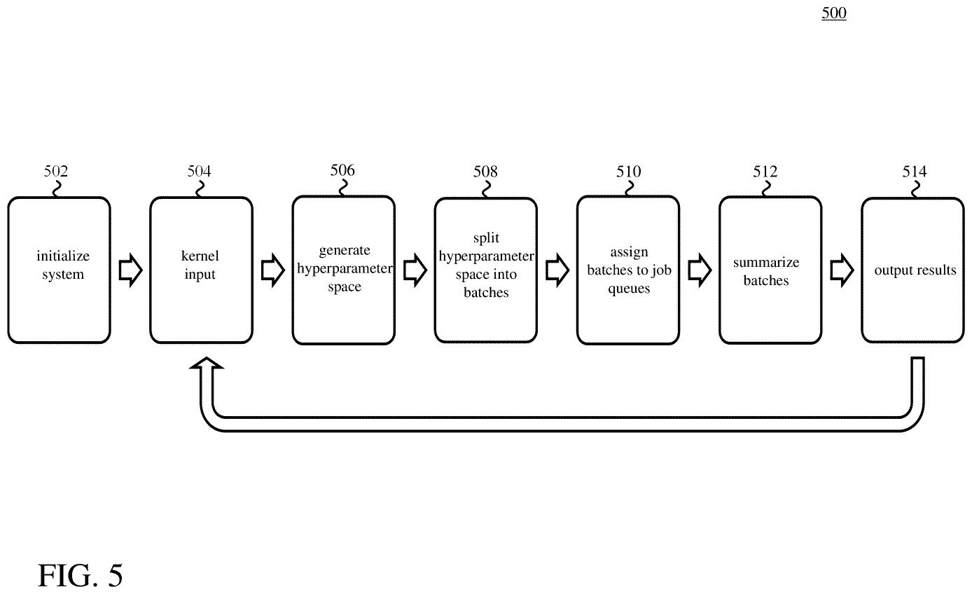

An example workflow for a main process (500) of an autotuner is illustrated in FIG. 5. The actions of main process (500) can be performed by an autotuner such as autotuner (310) of FIG. 3. In the example, the workflow begins by initializing (502) the system (e.g., initializing a server system that implements the autotuner such as server system (302) of FIG. 3). Initializing the system can include priming the accelerators, initializing context, and performing tasks such as determining how many accelerators the system has in order to appropriately distribute the workload across all the accelerators.

After the system is initialized, one accelerator kernel is input (504) to the system at a time. In particular, the autotuner is configured to tune individual accelerator kernels separately, as opposed to performing end-to-end tuning of a machine learning model including several accelerator kernels. As an illustrative example, a given machine learning model may include multiple different accelerator kernels such as GEMM kernels. Each GEMM kernel has corresponding parameters M, N, and K which are the dimensions of the matrix multiplication; GEMM kernels with different values of M, N, and K are tuned separately by the autotuner. Once the autotuner writes the result for one such GEMM kernel, it repeats the process for each different GEMM. Optionally, hyperparameters and tuning settings for the accelerator kernel may also be input to the autotuner.

Next, a hyperparameter space is generated (506) for the accelerator kernel to be tuned. For example, as shown in FIG. 4, the autotuner may receive hyperparameters associated with the input accelerator kernel. During generation of the hyperparameter space, the autotuner can identify possible values for each hyperparameter. For example, tile dimension is a hyperparameter which can have values ranging from 32 to 256). Generating the hyperparameter space also includes gathering all the different hyperparameter combinations that are possible. As an illustrative example, for a two-dimensional hyperparameter space with hyperparameters x and y, where x has five possible values and y has five possible values, the corresponding hyperparameter space has 25 values (i.e., as 5×5=25). Similarly, if for a ten-dimensional hyperparameter space with ten hyperparameters, each of which has two possible values, the corresponding hyperparameter space has 210=1024 values.

After generating the hyperparameter space, the main process (500) splits (508) the hyperparameter space into batches of hyperparameter combinations and assigns (510) the batches to respective job queues implemented by the accelerators of the autotuner. The size of the batches may be specified as one of the tuning settings input to the autotuner (e.g., a maximum batch size tuning option). Each accelerator can implement one job queue; accordingly, in an example where the autotuner includes n accelerators, there can be n job queues which run concurrently in parallel to each other on the n accelerators. Within a given job queue, batches assigned to the given job queue are processed sequentially.

In some examples, the assignment of the batches to the job queues occurs in tandem with the splitting of the hyperparameter space. In such examples, a first batch can be populated with hyperparameter combinations until the specified maximum batch size is reached, at which point the first batch is submitted to the job queue (e.g., for processing by a first accelerator). A second batch can then be populated with further hyperparameter combinations until the specified maximum batch size is reached, at which point the second batch is submitted to the job queue (e.g., for processing by a second accelerator). In this way, the autotuner can continue to push batches to the job queues until the entire hyperparameter space has been explored.

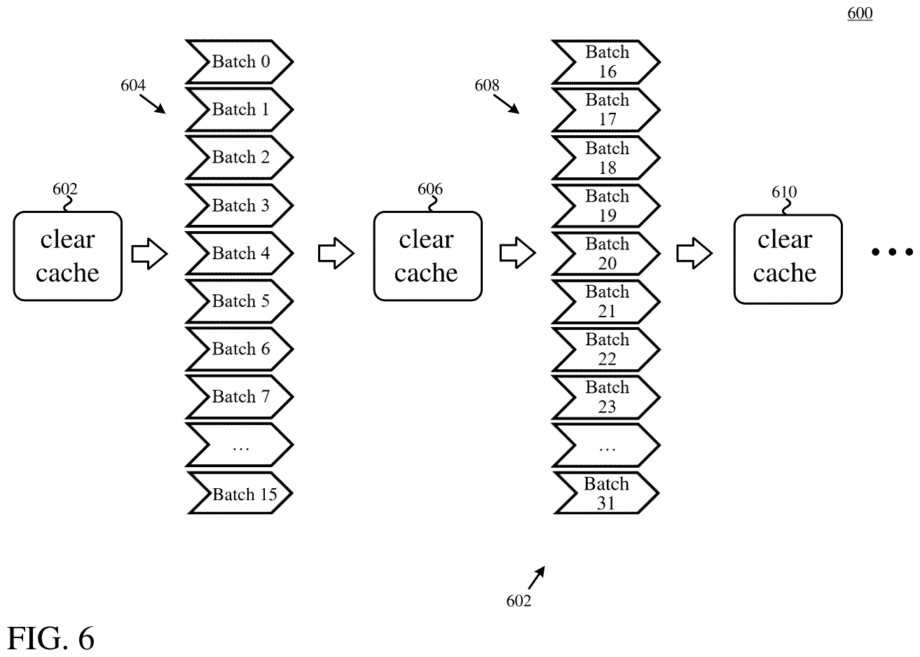

An example workflow (600) for parallel processing of batches by the accelerators of an autotuner is shown in FIG. 6. In the example, there are eight job queues and eight accelerators; each job queue runs on a corresponding one of the accelerators. After an optional first step in which the accelerators first clear (602) their respective caches, the first eight batches in the job queues (Batches 0-7) run concurrently in parallel to each other on the eight accelerators as indicated at (604).

After the first eight batches are done (i.e., after the respective worker processes for each of Batches 0-7 have completed), the caches of the accelerators are optionally cleared (606) to free up space. This can be helpful because a given accelerator writes files on the disk every time it runs kernels. As a result, the amount of data stored in the cache of the given accelerator continues to grow, which in turn can cause the system to slow down. Certain types of kernels may run on accelerators with minimal disk usage; when batches including such kernels are run on the accelerators, the clear cache step may be skipped. The tuning settings input to the autotuner can optionally include an indication of whether the accelerators should clear their caches between batches.

Next, the following eight batches in the job queues (Batches 16-31) are run on the accelerators as indicated at (608), after which the accelerator caches are optionally cleared (610). As indicated by the ellipsis mark, the accelerators continue to process waves of batches, and optionally clear their caches between batches, until all batches of hyperparameter combinations have been processed.

Returning to FIG. 5, the autotuner can be configured to populate the job queues based on relative load levels of the accelerators to balance the load among the accelerators. For example, the main process (500) can monitor the load levels of the accelerators (e.g., continuously or at predetermined intervals) and assign the batches to the job queues based on the relative load levels of the accelerators, e.g., such that a given batch is assigned to the accelerator which currently has the lightest load.

The work is sent in batches to the accelerators because there is some overhead in initializing the accelerators. Batching also improves the efficiency of the processors (e.g., CPU cores) on the server system which implement the autotuner. For example, for a given accelerator kernel, one of the processors builds the kernel code and then one of the accelerators executes the kernel code. When a larger batch size is used, the load on the processor is increased relative to the load on the processor for a smaller batch size. Accordingly, batching helps to ensure effective usage of the processors and avoid bottlenecks in the server system.

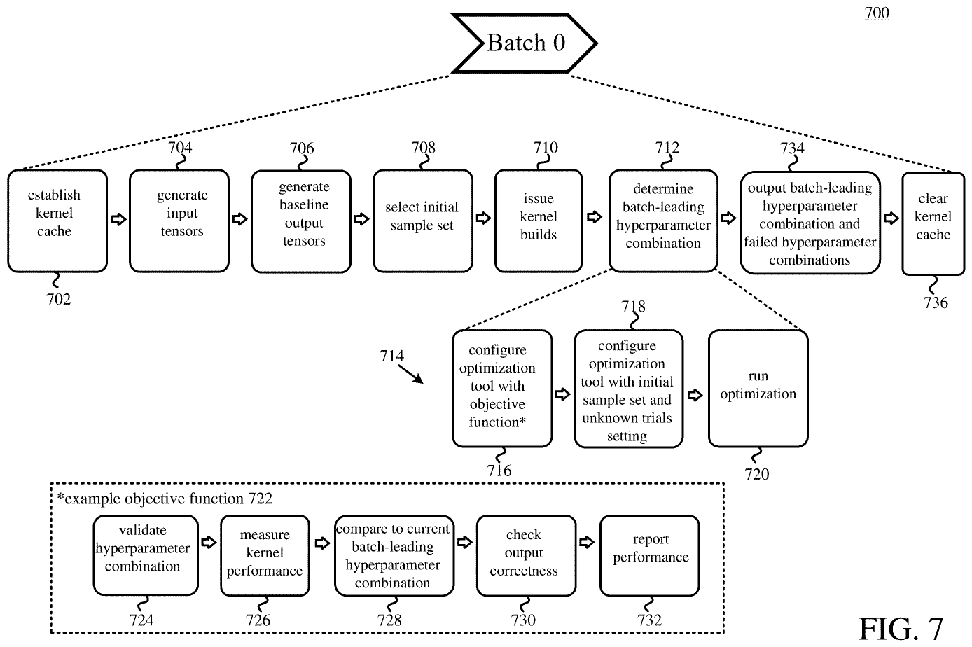

An example workflow for a worker process (700) of an autotuner is illustrated in FIG. 7. Worker process (700) represents one of a plurality of worker processes performed by respective accelerators of an autotuner (e.g., accelerators (230) of FIG. 2). In particular, the accelerators of the autotuner perform respective worker processes (700), each of which processes a single tuning batch at a time. As described herein, a given worker process (700) is responsible for kernel compilation, kernel execution, and reporting of partial results in a persistent manner (e.g., as required for reentrancy).

The worker process (700) for an example batch (Batch 0) begins with establishment (702) of a kernel cache (e.g., a kernel cache directory for storing temporary build files). For example, kernel storage (316) of FIG. 3 may include respective kernel caches of the autotuner accelerators. The batch includes multiple hyperparameter combinations; the number of hyperparameter combinations may correspond to a maximum batch size tuning setting of the autotuner.

Next, input tensors are generated (704) and baseline tensors are generated (706). For example, if the value of a number of input sets tuning setting is N, the worker process (700) may generate N sets of input and baseline tensors, with each set including one input tensor and one baseline tensor. The input and baseline tensors can include randomly generated values used for correctness validation. A kernel for a given hyperparameter combination of the batch can be run once for each set of input and baseline tensors before calculation of the mean performance for the given hyperparameter combination.

After generating the input and baseline tensors, the worker process (700) selects (708) an initial sample set of valid hyperparameter combinations for the batch. For example, this can include the worker process (700) randomly selecting a hyperparameter combination from the batch, determining whether the selected hyperparameter combination is valid, and if so, adding it to the initial sample set. This process can be repeated until the number of hyperparameter combinations in the initial sample set matches the known trials setting (e.g., until the number of hyperparameter combinations in the initial sample set corresponds to the known trials percentage of the hyperparameter combinations in the batch).

After generating the initial sample set, the worker process (700) issues (710) kernel builds for the initial sample set. For example, the kernels can be built by one or more CPUs of the autotuner to maximize CPU utilization and proactively prepare the kernels for execution.

The worker process (700) then determines (712) the batch-leading hyperparameter combination for the batch, which includes the worker process (700) performing a sub-process (714). Sub-process (714) begins with the worker process (700) configuring (716) an optimization tool (e.g., optimization tool (306) of FIG. 3) with an objective function. Configuring the optimization tool with the objective function can include, for example, inputting a definition of the objective function to the optimization tool. As described further herein, the objective function can be executed by the optimization tool to validate a hyperparameter combination, measure kernel performance, compare the hyperparameter combination to a current batch-leading hyperparameter combination for the batch, and check output correctness for the kernel.

Next, the worker process (700) configures (718) the optimization tool with the initial sample set of hyperparameter combinations and an unknown trials setting. As described further herein, the value of the unknown trials setting dictates the percentage of hyperparameter combinations in the batch that will be sampled by the optimization tool in addition to the known trials (i.e., in addition to the initial sample set). Optionally, at this stage, the worker process (700) can perform additional configuration of the optimization tool (e.g., selection of a desired optimization technique or other settings). In some examples, the optimization tool may perform a certain optimization technique (e.g., Bayesian optimization) by default unless configured otherwise.

After configuring the optimization tool, the worker process (700) runs (720) optimization for the batch using the optimization tool. This can include the optimization tool applying an optimization technique to select additional hyperparameter combinations to evaluate from the batch; the number of unknown hyperparameter combinations that are selected is determined by the unknown trials setting. The selected additional hyperparameter combinations can alternatively be referred to as “unknown” hyperparameter combinations (e.g., as they are not part of the initial sample set which has already been evaluated and are unknown until selected by the optimization tool).

After a given unknown hyperparameter combination is selected, the optimization tool evaluates the given unknown hyperparameter combination. Towards this end, the optimization tool calls the objective function for the given unknown hyperparameter combination. After being called by the optimization tool, the objective function is executed by the hardware of the autotuner (e.g., certain actions associated with the execution of the objective function are performed by one or more of the CPUs of the autotuner (e.g. kernel building), and certain other actions associated with the execution of the objective function are performed by one or more of the accelerators of the autotuner (e.g. kernel execution)).

As shown, during execution of an example objective function (722) for a given unknown hyperparameter combinations, the given unknown hyperparameter combination is first validated (724). Next, kernel performance for the given unknown hyperparameter combination is measured (726). For example, this can include triggering the worker process (700) to issue a kernel build for the given unknown hyperparameter combination, which is then executed on the accelerator; during the execution of the kernel build, kernel performance is measured for the given unknown hyperparameter combination. The measurement of the kernel performance can include measurement of one or more performance metrics such as runtime, floating-point operations per second (also referred to as FLOPS), tera floating-point operations per second (also referred to as teraflops or TFLOPS), and/or throughput.

The objective function (722) then compares (728) the kernel performance for the given unknown hyperparameter combination to that of the current batch-leading hyperparameter combination for the batch. For example, one or more performance metrics for the given unknown hyperparameter combination can be compared to one or more previously determined performance metrics for the current batch-leading hyperparameter combination for the batch.

Next, output correctness is checked (730) for the build for the given unknown hyperparameter combination), and the measured performance is reported (732). This can include reporting one or more performance metrics, reporting the result of the performance comparison performed at (728), and/or reporting the result of the output correctness check performed at (730). For example, if the comparison of a kernel performance metric for the given unknown hyperparameter combination to a kernel performance metric for the current batch-leading hyperparameter combination reveals that the given unknown hyperparameter combination achieved better kernel performance than the current batch-leading hyperparameter combination (e.g., a shorter runtime and/or a higher throughput), and the output correctness check confirms that the kernel output for the given unknown hyperparameter combination was correct, the given unknown hyperparameter combination can be designated as the current batch-leading hyperparameter combination for the batch (and, the prior batch-leading hyperparameter combination for the batch can be re-designated as a failed hyperparameter combination). In such an example, reporting the performance of the given unknown hyperparameter combination can include outputting an indication that the given unknown hyperparameter combination is the current batch-leading hyperparameter combination and the prior batch-leading hyperparameter combination is a failed hyperparameter combination.

In contrast, if the comparison of the kernel performance metric for the given unknown hyperparameter combination to the kernel performance metric for the current batch-leading hyperparameter combination for the batch reveals that the given hyperparameter combination achieved worse kernel performance than the current batch-leading hyperparameter combination (e.g., a longer runtime and/or a lower throughput), and/or if the output correctness check indicates that the kernel output for the given hyperparameter combination was incorrect, the given hyperparameter combination can be labeled as a failed hyperparameter combination. Accordingly, in such an example, reporting the performance of the given hyperparameter combination can include outputting an indication that the given hyperparameter combination is a failed hyperparameter combination.

In some examples, during execution of the kernel build for the first unknown hyperparameter combination in a batch, the most effective hyperparameter combination of the initial sample set can initially serve as the current batch-leading hyperparameter combination for the batch. In other examples, the most effective hyperparameter combination of the initial sample set can instead be compared with the most effective unknown hyperparameter combination after the unknown hyperparameter combinations have all been evaluated. Accordingly, in this situation, the first hyperparameter combination can be designated as the current batch-leading hyperparameter combination for the batch after passing the output correctness check, or as a failed hyperparameter combination after failing the output correctness check. In the latter case, the subsequent hyperparameter combination(s) in the batch can be treated similarly; i.e., the hyperparameter combination that is the first one to pass the output correctness check can become the de facto current batch-leading hyperparameter combination for the batch and remain so until a kernel for a subsequent hyperparameter combination with a better performance and correct output is identified.

The optimization tool then proceeds to execute the objective function for the next unknown hyperparameter combination. After the objective function has been executed for each of the unknown hyperparameter combinations (i.e., for the number of unknown hyperparameter combinations specified by the unknown trials setting), the batch-leading hyperparameter combination for the batch and the failed hyperparameter combinations for the batch are output (734) to the main process (500) shown in FIG. 5. Optionally, after this step, the worker process (700) clears (736) the kernel cache to free up disk space.

Returning to FIG. 5, after all batches have been processed via respective worker processes (700), the main process (500) collects the statistics from each batch and summarizes (512) the results from all the batches. This can include the main process (500) determining which of the batch-leading hyperparameter combinations is the overall-leading hyperparameter combination. Optionally, the main process (500) can also classify certain batch-leading hyperparameter combinations as contender hyperparameter combinations. For example, a given batch-leading hyperparameter combination with a performance metric (e.g., runtime, floating-point operations per second, or throughput) within a threshold specified by a contender variance setting of a performance metric of the overall-leading hyperparameter combination may be classified as a contender hyperparameter combination

The main process (500) then outputs (514) the results (e.g., the overall-leading hyperparameter combination, and optionally, contender hyperparameter combination(s)). Outputting the results can include writing the results to an output file, for example. The results can then be used by a workload at runtime to select an effective hyperparameter combination for execution of the kernel. Additionally or alternatively, certain results such as the overall-leading hyperparameter combination can be output to a tuned kernel execution and benchmarking tool, as described above with reference to FIG. 4. The tuned kernel execution and benchmarking tool can be configured to receive overall-leading hyperparameter combinations from the autotuner for a plurality of kernels of a machine learning model. The tuned kernel execution and benchmarking tool can execute the tuned kernels in an end-to-end inference run of the machine learning model to perform benchmarking of the machine learning model.

### VII. Example Approaches for Comparing Performance Metrics.

As described herein, performance metrics for hyperparameter combinations of a given batch can be compared to determine a batch-leading hyperparameter combination, and performance metrics for multiple batch-leading hyperparameter combinations can be compared to determine an overall-leading hyperparameter combination. The batch-leading hyperparameter combination for a given batch can refer to the hyperparameter combination with the best performance among the hyperparameter combinations in the given batch in view of a single performance metric or a combination of performance metrics, which is alternatively referred to as the most effective hyperparameter combination for the given batch. Similarly, the overall-leading hyperparameter combination for a given kernel can refer to the batch-leading hyperparameter combination with the best performance among the batch-leading hyperparameter combinations for the given kernel in view of a single performance metric or a combination of performance metrics, which is alternatively referred to as the most effective hyperparameter combination for the given kernel.

For example, the performance metric used to determine the batch-leading hyperparameter combinations and the overall-leading hyperparameter combination for a given kernel can be kernel runtime. In such an example, kernel runtime values for the hyperparameter combinations of a given batch can be compared, and the hyperparameter combination with the lowest kernel runtime value in the given batch can be selected as the batch-leading hyperparameter combination. Similarly, kernel runtime values for the batch-leading hyperparameter combinations for a given kernel can be compared, and the batch-leading hyperparameter combination with the lowest kernel runtime value can be selected as the overall-leading hyperparameter combination.

As another example, the performance metric used to determine the batch-leading hyperparameter combinations and the overall-leading hyperparameter combination for a given kernel can be FLOPS. In such an example, FLOPS values for the hyperparameter combinations of a given batch can be compared, and the hyperparameter combination with the highest FLOPS value in the given batch can be selected as the batch-leading hyperparameter combination. Similarly, FLOPS values for the batch-leading hyperparameter combinations for a given kernel can be compared, and the batch-leading hyperparameter combination with the highest FLOPS value can be selected as the overall-leading hyperparameter combination.

As yet another example, the performance metric used to determine the batch-leading hyperparameter combinations and the overall-leading hyperparameter combination for a given kernel can be kernel throughput. In such an example, kernel throughput values for the hyperparameter combinations of a given batch can be compared, and the hyperparameter combination with the highest kernel throughput value in the given batch can be selected as the batch-leading hyperparameter combination. Similarly, kernel throughput values for the batch-leading hyperparameter combinations for a given kernel can be compared, and the batch-leading hyperparameter combination with the highest kernel throughput value can be selected as the overall-leading hyperparameter combination.

In other examples, a combination of selected performance metrics (e.g., any two or more of the above performance metrics) can be used to determine the batch-leading hyperparameter combinations and the overall-leading hyperparameter combination for a given kernel. In such examples, determining the batch-leading hyperparameter combination for a given batch can include ranking the different hyperparameter combinations of the given batch according to each of the selected performance metrics, combining the rank values for each of the hyperparameter combinations, and selecting the hyperparameter combination with the lowest (best) combined rank as the batch-leading hyperparameter combination. Similarly, in such examples, determining the overall-leading hyperparameter combination for a given kernel can include ranking the batch-leading hyperparameter combinations of the given kernel according to each of the selected performance metrics, combining the rank values for each batch-leading hyperparameter combinations, and selecting the batch-leading hyperparameter combination with the lowest (best) combined rank as the overall-leading hyperparameter combination.

Alternatively, when a combination of selected performance metrics is used to determine the batch-leading hyperparameter combinations, the different hyperparameter combinations of the given batch can be scored according to each of the selected performance metrics. The score values for each of the hyperparameter combinations can be combined, and the hyperparameter combination with the highest (best) combined score can be selected as the batch-leading hyperparameter combination. Similarly, when a combination of selected performance metrics is used to determine the overall-leading hyperparameter combination for a given kernel, the batch-leading hyperparameter combinations of the given kernel can be scored according to each of the selected performance metrics. The score values for each batch-leading hyperparameter combination can be combined, and the batch-leading hyperparameter combination with the highest (best) combined score can be selected as the overall-leading hyperparameter combination. Depending on implementation, score values for a given selected performance metric can be weighted, relative to other selected performance metrics, to increase or decrease the impact of the given selected performance metric on the combined score.

It will be appreciated that similar processes can be performed for comparing the performance metrics or combinations of performance metrics. Similarly, performance metrics other than or in addition to those specifically described herein can be used to evaluate the performance of a given hyperparameter combination.

### VIII. Example Approaches for Autotuning Kernels.

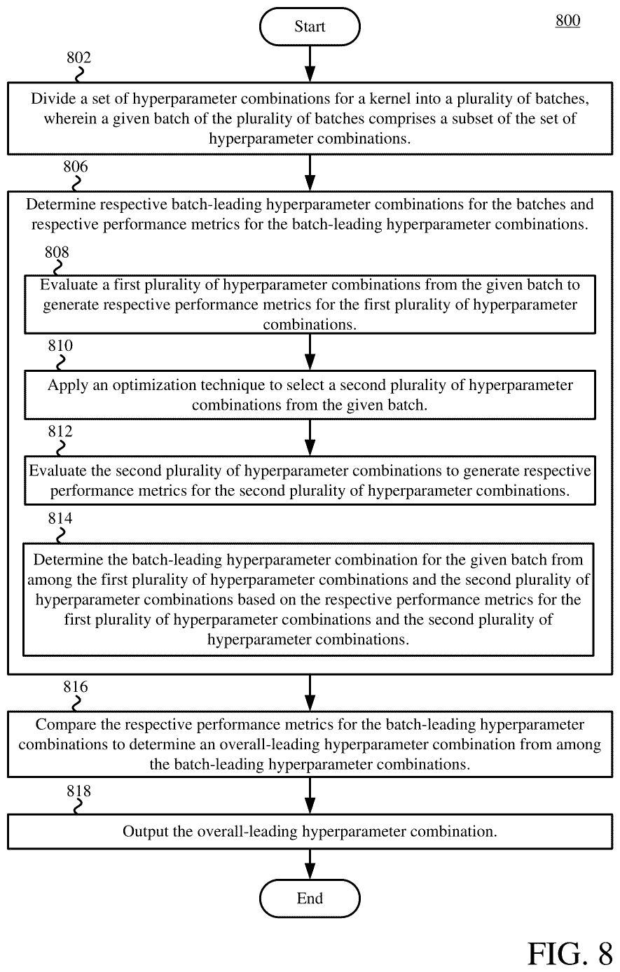

FIG. 8 shows a generalized technique (800) for autotuning kernels. The technique (800) can be performed by an autotuner as described in the preceding sections, or by another tool or component.

As shown, the technique (800) includes dividing (802) a set of hyperparameter combinations for a kernel into a plurality of batches, wherein a given batch of the plurality of batches comprises a subset of the hyperparameter combinations for the kernel. For example, as shown in FIG. 4, an autotuner can receive a kernel along with hyperparameters; combinations of the hyperparameters collectively form a hyperparameter space for the kernel which includes hyperparameter combinations for the kernel (in some examples, all possible hyperparameter combinations for the kernel). In contrast to approaches in which only part of the hyperparameter space for a kernel is explored, the technique (800) can divide the entire hyperparameter space (i.e., the entire set of hyperparameter combinations for the kernel) into batches which are individually processed by respective worker processes as described herein. Each batch can include a disjoint subset of the set of hyperparameter combinations, such that a given hyperparameter combination only appears in a single one of the batches.

A tuning configuration for an autotuner can include a maximum batch size setting with a value that specifies a maximum number of hyperparameter combinations per batch; in this case, the number of hyperparameter combinations in the given batch can be equal to the value of the maximum batch size setting, or less than the value of the maximum batch size setting (e.g., if the given batch is the last among the plurality of batches and the number of remaining hyperparameter combinations is less than the maximum batch size setting).

Next, the technique (800) includes determining (806) respective batch-leading hyperparameter combinations for the batches and respective performance metrics for the batch-leading hyperparameter combinations. As shown, this can include evaluating (808) a first plurality of hyperparameter combinations from the given batch to generate respective performance metrics for the first plurality of hyperparameter combinations. The first plurality of hyperparameter combinations, which is alternatively referred to herein as an initial sample set, can include a predefined number of valid hyperparameter combinations selected from among the hyperparameter combinations of the given batch. A valid hyperparameter combination for a given kernel can refer to a hyperparameter combination that can be implemented effectively on the target hardware (e.g., a valid hyperparameter combination for an accelerator kernel can be implemented effectively on an accelerator).

In contrast, an invalid hyperparameter combination for a given kernel can refer to a hyperparameter combination that cannot be implemented effectively on the target hardware. For example, this may occur when one or more hyperparameters in the given combination have values that are unsupported by the target hardware (e.g., a thread block size that exceeds the maximum thread block size supported by a target accelerator, a memory access pattern that is incompatible with a memory hierarchy of a target accelerator, etc.) As another example, this may occur when one or more hyperparameters in the given combination result in resource utilization beyond the capabilities of the target hardware.

Optionally, after the generation of the performance metrics for the first plurality of hyperparameter combinations from the given batch, the respective performance metrics for the first plurality of hyperparameter combinations can be compared to one another determine the most effective hyperparameter combination among the first plurality of hyperparameter combinations. The most effective hyperparameter combination among the first plurality of hyperparameter combinations can be designated as a current batch-leading hyperparameter combination for the batch.

As shown, the determining (806) can further include applying (810) an optimization technique to select a second plurality of hyperparameter combinations from the given batch. For example, as described herein with reference to FIG. 7, a worker process can configure an optimization tool to apply an optimization technique to make informed selections of which hyperparameter combinations to evaluate (e.g., based on information such as performance metrics from the evaluation of the initial sample set and, if available, performance metrics of other hyperparameter combinations of the batch which have already been evaluated).

In addition, the determining (806) can include evaluating (812) the second plurality of hyperparameter combinations to generate respective performance metrics for the second plurality of hyperparameter combinations, and determining (814) the batch-leading hyperparameter combination for the given batch from among the first plurality of hyperparameter combinations and the second plurality of hyperparameter combinations. For example, as described above with reference to FIG. 7, an optimization tool can call an objective function for each hyperparameter combination of the second plurality of hyperparameter combinations which serves to validate the hyperparameter combination, evaluate the hyperparameter combination, measure kernel performance for the hyperparameter combination, and determine whether the kernel performance exceeds that of the current batch-leading hyperparameter combination for the batch. In examples where the most effective hyperparameter combination of the first plurality of hyperparameter combinations is designated as the current batch-leading hyperparameter combination prior to the evaluation of the second plurality of hyperparameter combinations, that hyperparameter combination can retain its designation as the current batch-leading hyperparameter combination until the technique (800) determines that one of the second plurality of hyperparameter combinations is more effective (e.g., has a better kernel performance as reflected by one or more performance metrics).

While steps (810) and (812) are each depicted once, in practice, steps (810) and (812) may be performed sequentially for each hyperparameter combination of the second plurality of hyperparameter combinations. For example, the optimization tool may select a first hyperparameter combination, evaluate the first hyperparameter combination, select a second hyperparameter combination to be evaluated based on the evaluation results for the first hyperparameter combination, and so on.

The technique (800) further includes comparing (816) the respective performance metrics for the batch-leading hyperparameter combinations for the batches to determine an overall-leading hyperparameter combination from among the batch-leading hyperparameter combinations, and outputting (818) the overall-leading hyperparameter combination. For example, this can include outputting the overall-leading hyperparameter combination to a tuned kernel execution benchmarking tool, or writing the overall-leading hyperparameter combination to an output file to be accessed by a workload at runtime.

While steps (808)-(814) describe the process of determining a batch-leading hyperparameter combination for a single batch and a corresponding performance metric, it will be appreciated that multiple such processes can be performed concurrently (e.g., in parallel). For example, as described herein with references to FIG. 6, respective worker processes of the autotuner may perform steps (808)-(814) for multiple batches, in parallel. Each worker process can be carried out, at least in part, on a respective one of a plurality of accelerators of the autotuner; accordingly, the number of accelerators of the autotuner can dictate the number of batches that may be processed simultaneously during autotuning.

### IX. Example Experimentation Results.

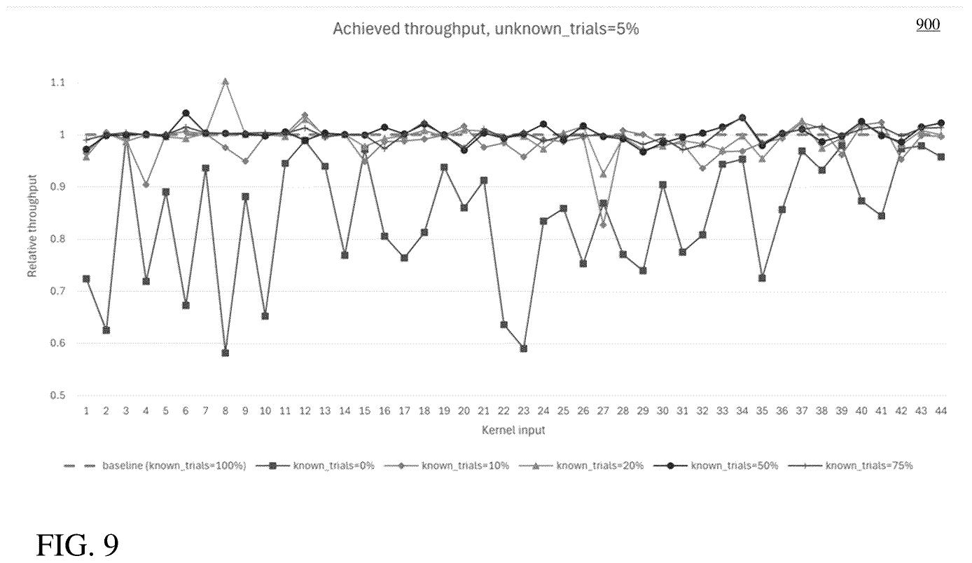

Example graphs illustrating how the values of the known trials and unknown trials settings can affect tuning performance and the achieved throughput are shown in FIGS. 9-12. The graphs shown in FIGS. 9-12 include the results of the autotuner for tuning of an FPx parameterized kernel which is part of a Mixture of Experts (MoE) model with a tuning batch size of 200 (i.e., a maximum batch size setting of 200) for 44 different inputs.

In the example, the square brackets notation is used to denote the number of trials used for tuning optimization. In particular, for an experiment with a value of M for the known trials setting and a value of N for the unknown trials setting, the notation [M: M+N] is used to denote the number of trials used for tuning optimization. For example, for an experiment with a value of 10 for the known trials setting and a value of 20 for the unknown trials setting, the notation [10:30] is used to denote the number of trials used for tuning optimization; in this example, a minimum of 10% and no more than 30% of the hyperparameter combinations in a tuning batch will be used for optimization.

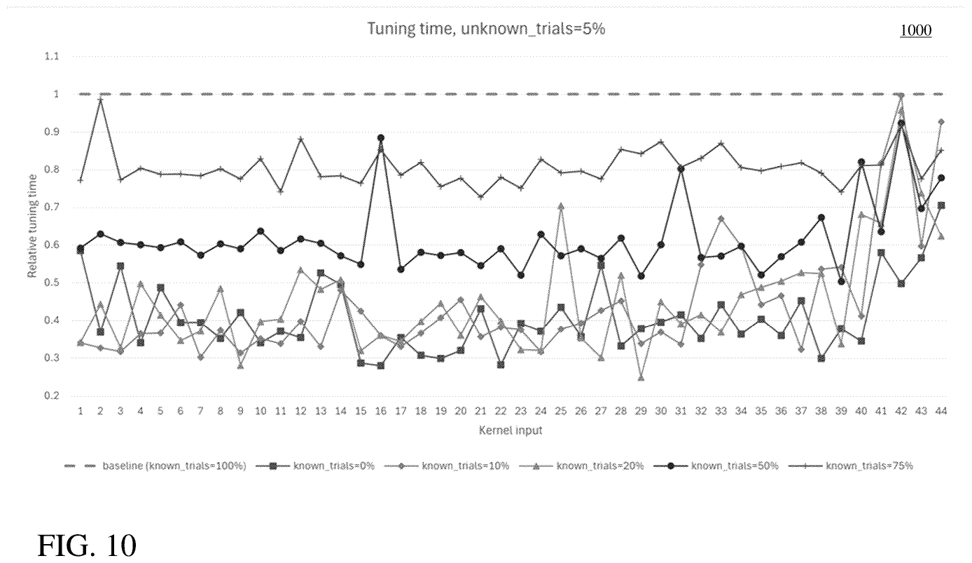

Graph (900) of FIG. 9 depicts the variance of achieved throughput with different values for the known trials setting and a fixed value of 5 for the unknown trials setting (i.e., [N:N+5]). In graph (900), the x-axis is labeled kernel input, whereas the y-axis is labeled relative throughput. Similarly, graph (1000) of FIG. 10 depicts the variance of tuning time with different values for the known trials setting and a fixed value of 5 for the unknown trials setting. In graph (900), the x-axis is labeled kernel input, whereas the y-axis is labeled relative tuning time. In graphs (900) and (1000), the numbers are reported relative to the baseline (dashed line at y=1) which is equivalent to brute force tuning (i.e., [100:100]).

Table 2 below summarizes the relative throughput and relative tuning time averaged over all the 44 kernels for the example shown in graphs (900) and (1000). As expected, increasing the number of known trials increases the amount of time it takes to tune. However, notably, greater than 98% throughput was achieved by brute force computation with only [10:15] trials, which took only ˜44% of the brute-force tuning time (see the second row of Table 2).

Further, the final achieved throughput saturates much before [100:100] (in this case at [50:55]); increasing the number of trials further results in unnecessary computation with no real benefit. This is because the optimization tool is able to guess the optimal combination without having to try all the combinations.

TABLE 2
Relative Throughput and Tuning Time for Different
Values of the Known Trials Setting

| | Mean relative | Mean relative |
|---|---|---|
| Trials | throughput | tuning time |
| [0:5] | 0.838 | 0.406 |
| [10:15] | 0.983 | 0.439 |
| [20:25] | 0.995 | 0.450 |
| [50:55] | 1.000 | 0.615 |
| [75:80] | 1.000 | 0.806 |
| [100:100] | 1.000 | 1.000 |

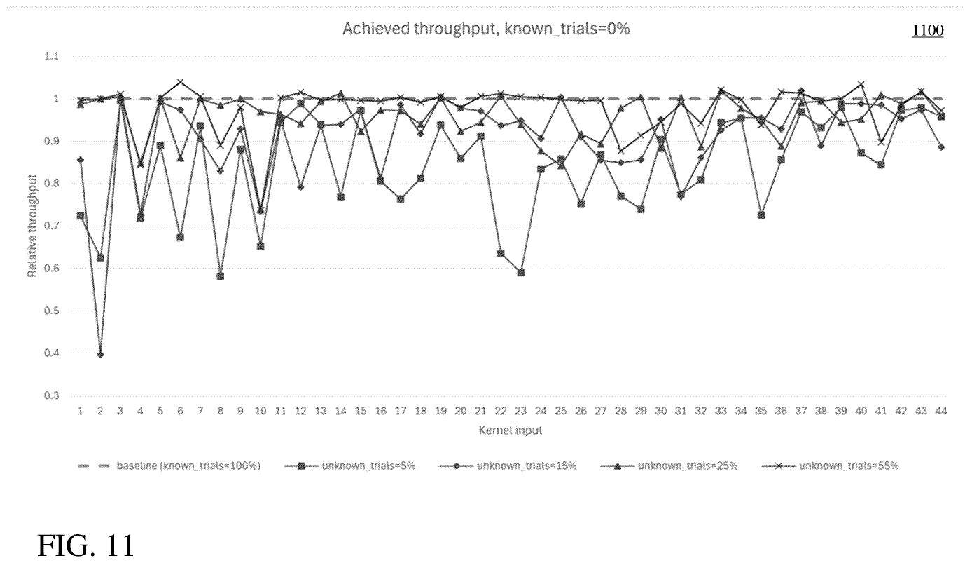

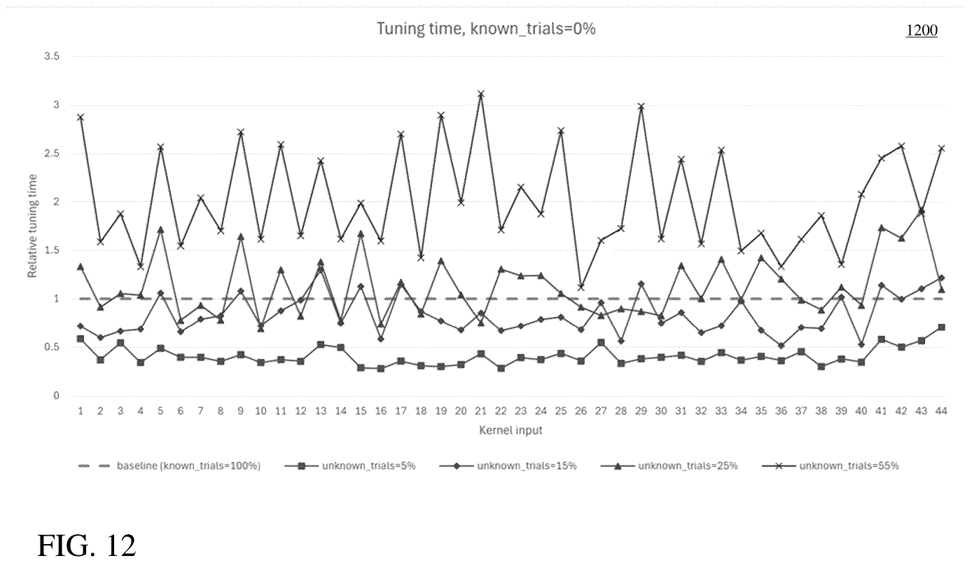

Graph (1100) of FIG. 11 depicts the variance of achieved throughput with different values for the unknown trials setting and a fixed value of 0 for the known trials setting (i.e., [0: N]). In graph (1100), the x-axis is labeled kernel input, whereas the y-axis is labeled relative throughput. Similarly, graph (1200) of FIG. 12 depicts the variance of tuning time with different values for the unknown trials setting and a fixed value of 0 for the known trials setting. In graph (1200), the x-axis is labeled kernel input, whereas the y-axis is labeled relative tuning time. In graphs (1100) and (1200), the numbers are again reported relative to the baseline (dashed line at y=1) which is equivalent to brute force tuning.

One of the key differences between known trials and unknown trials is that it is more expensive (in terms of tuning time) to run a given number of unknown trials than it is to run the same number of known trials. As shown in Table 3 below, setting the value of the unknown trials setting to 25% incurs a tuning time greater than that of the brute force search. This is due to the overhead of the optimization tool used for suggesting hyperparameter combinations; running the known trials does not incur this overhead, as it does not involve the optimization tool. Therefore, the value of the known trials setting should be set to the lower bound of the sample set size.

TABLE 3
Relative Throughput and Tuning Time for Different
Values of the Unknown Trials Setting

| | Mean relative | Mean relative |
|---|---|---|
| Trials | throughput | tuning time |
| [0:5] | 0.838 | 0.406 |
| [0:15] | 0.906 | 0.830 |
| [0:25] | 0.958 | 1.123 |
| [0:55] | 0.978 | 2.016 |
| [100:100] | 1.000 | 1.000 |

However, it is worth mentioning that setting the value of the unknown trials setting to 0 should be avoided unless the value of the known trials setting is set to 100, because otherwise the chances of finding an effective tuning configuration will depend on the likelihood of it being one of the known trials. For example, for tuning setting [60:0], the likelihood of finding an effective tuning parameter combination is 60%. This is because the autotuner only uses 60% of the combinations of each batch and the optimization tool is not given the opportunity to suggest better combinations.

### X. EXAMPLES

The innovative features described herein include the following examples.

| | Example |
|---|---|
| A1 | A computer-readable medium having stored thereon computer-executable |
| | instructions for causing a computer system, when programmed thereby, to perform |
| | operations for autotuning kernel hyperparameters, the operations comprising: |
| | dividing a set of hyperparameter combinations for a kernel into a plurality of |
| | batches, wherein a given batch of the plurality of batches comprises a subset of the |
| | set of hyperparameter combinations; |
| | determining respective batch-leading hyperparameter combinations for the |
| | batches and respective performance metrics for the batch-leading hyperparameter |
| | combinations, wherein determining the batch-leading hyperparameter combination |
| | for the given batch and the performance metric for the batch-leading hyperparameter |
| | combination for the given batch comprises: |
| | evaluating a first plurality of hyperparameter combinations from the |
| | given batch to generate respective performance metrics for the first plurality |
| | of hyperparameter combinations; |
| | applying an optimization technique to select a second plurality of |
| | hyperparameter combinations from the given batch; |
| | evaluating the second plurality of hyperparameter combinations to |
| | generate respective performance metrics for the second plurality of |
| | hyperparameter combinations; and |
| | determining the batch-leading hyperparameter combination for the |
| | given batch from among the first plurality of hyperparameter combinations |
| | and the second plurality of hyperparameter combinations based on the |
| | respective performance metrics for the first plurality of hyperparameter |
| | combinations and the second plurality of hyperparameter combinations; |
| | comparing the respective performance metrics for the batch-leading |
| | hyperparameter combinations to determine an overall-leading hyperparameter |
| | combination from among the batch-leading hyperparameter combinations; and |
| | outputting the overall-leading hyperparameter combination. |
| A2 | The computer-readable medium of A1, wherein the set of hyperparameter |
| | combinations comprises all possible hyperparameter combinations for the kernel, |
| | and wherein the batches collectively comprise all of the possible hyperparameter |
| | combinations for the kernel. |
| A3 | The computer-readable medium of A1 or A2, wherein the first plurality of |
| | hyperparameter combinations are randomly selected to form an initial sample set, |
| | and wherein the operations further comprise, prior to evaluating the first plurality of |
| | hyperparameter combinations: |
| | determining that a number of hyperparameter combinations in the initial |
| | sample set is less than a predefined initial sample set size; |
| | randomly selecting a given hyperparameter combination from among the |
| | hyperparameter combinations of the given batch; |
| | determining that the given hyperparameter combination is valid for the |
| | kernel; and |
| | adding the given hyperparameter combination to the initial sample set. |
| A4 | The computer-readable medium of any one of A1-A3, wherein the |
| | optimization technique is selected from the group consisting of Bayesian |
| | optimization, grid search, random sampling, Monte Carlo sampling, and brute force |
| | search. |
| A5 | The computer-readable medium of claim 1, wherein determining the batch- |
| | leading hyperparameter combination for the given batch from among the first |
| | plurality of hyperparameter combinations and the second plurality of |
| | hyperparameter combinations based on the respective performance metrics for the |
| | first plurality of hyperparameter combinations and the second plurality of |
| | hyperparameter combinations comprises: |
| | determining a subset of valid hyperparameter combinations from among the |
| | second plurality of hyperparameter combinations; |
| | comparing the respective performance metrics for the subset of valid |
| | hyperparameter combinations and the first plurality of hyperparameter |
| | combinations; |
| | determining a most effective hyperparameter combination from among the |
| | subset of valid hyperparameter combinations and the first plurality of |
| | hyperparameter combinations based on the comparison, wherein the most effective |
| | hyperparameter combination provides a best kernel performance among the |
| | hyperparameter combinations of the subset of valid hyperparameter combinations |
| | and the first plurality of hyperparameter combinations; and |
| | designating the most effective hyperparameter combination as the batch- |
| | leading hyperparameter combination for the given batch. |
| A6 | The computer-readable medium of any one of A1-A5, wherein the operations |
| | further comprise receiving a tuning configuration for the kernel, and wherein the |
| | tuning configuration comprises respective values for one or more tuning settings. |
| A7 | The computer-readable medium of A6, wherein: |
| | the tuning settings comprise a known trials setting and an unknown trials |
| | setting; |
| | the value of the known trials setting is a first percentage; |
| | the value of the unknown trials setting is a second percentage; |
| | a number of hyperparameter combinations in the first plurality of |
| | hyperparameter combinations is determined as the first percentage of a total number |
| | of the hyperparameter combinations in the given batch; and |
| | a number of hyperparameter combinations in the second plurality of |
| | hyperparameter combinations is determined as the second percentage of the total |
| | number of the hyperparameter combinations in the given batch. |
| A8 | The computer-readable medium of A6 or A7, wherein the tuning settings |
| | further comprise at least one of the following: |
| | a continue session setting which can be enabled to allow storage of partial |
| | tuning results and resumption of a previous tuning session; |
| | a maximum batch size setting with a value that specifies a maximum number |
| | of hyperparameter combinations per batch; or |
| | a contender variance setting with a value that specifies a maximum |
| | percentage of acceptable variance for performance metrics of contender |
| | hyperparameter combinations to corresponding performance metrics of the overall- |
| | leading hyperparameter combination. |
| A9 | The computer-readable medium of any one of A1-A8, wherein determining |
| | the respective batch-leading hyperparameter combinations for the batches and the |
| | respective performance metrics for the batch-leading hyperparameter combinations |
| | comprises: |
| | assigning the batches to respective job queues; and |
| | performing parallel processing of the job queues on respective accelerators. |
| A10 | The computer-readable medium of any one of A1-A9, wherein determining |
| | the batch-leading hyperparameter combination for the given batch and the |
| | performance metric for the batch-leading hyperparameter combination comprises: |
| | establishing a kernel cache for the given batch; |
| | generating respective input tensors for the hyperparameter combinations of |
| | the given batch; and |
| | generating respective baseline output tensors for the hyperparameter |
| | combinations of the given batch. |
| A11 | The computer-readable medium of any one of A1-A10, wherein the |
| | performance metrics comprise at least one of the following: |
| | kernel runtime; |
| | kernel floating-point operations per second during execution; or |
| | kernel throughput. |
| A12 | The computer-readable medium of any one of A1-A11, wherein evaluating |
| | the second plurality of hyperparameter combinations to generate the respective |
| | performance metrics for the second plurality of hyperparameter combinations |
| | comprises: |
| | validating a given hyperparameter combination of the second plurality of |
| | hyperparameter combinations; |
| | determining a performance metric for the given hyperparameter combination; |
| | comparing the performance metric for the given hyperparameter combination |
| | to a performance metric for a current batch-leading hyperparameter combination of |
| | the given batch; |
| | determining whether a kernel output for the given hyperparameter |
| | combination is correct; and |
| | reporting the performance metric for the given hyperparameter combination. |
| A13 | The computer-readable medium of any one of A1-A12, wherein comparing |
| | the respective performance metrics for the batch-leading hyperparameter |
| | combinations to determine the overall-leading hyperparameter combination from |
| | among the batch-leading hyperparameter combinations comprises: |
| | comparing the respective performance metrics for the batch-leading |
| | hyperparameter combinations; |
| | determining a most effective hyperparameter combination from |
| | among the batch-leading hyperparameter combinations based on the |
| | comparison, wherein the most effective hyperparameter combination |
| | provides a best kernel performance among the batch-leading hyperparameter |
| | combinations; and |
| | designating the most effective hyperparameter combination as the |
| | overall-leading hyperparameter combination. |
| A14 | The computer-readable medium of any one of A1-A13, wherein the |
| | operations further comprise, after determining the batch-leading hyperparameter |
| | combination for the given batch: |
| | designating the hyperparameter combinations of the given batch that are not |
| | the batch-leading hyperparameter combination as failed hyperparameter |
| | combinations; and |
| | outputting the failed hyperparameter combinations; |
| | wherein comparing the respective performance metrics for the batch-leading |
| | hyperparameter combinations to determine the overall-leading hyperparameter |
| | combination from among the batch-leading hyperparameter combinations |
| | comprises: |
| | determining that the respective performance metrics for one or more of the |
| | batch-leading hyperparameter combinations are within a predefined range of the |
| | performance metric for the overall-leading hyperparameter combination; and |
| | outputting the one or more of the batch-leading hyperparameter |
| | combinations as contender hyperparameter combinations. |
| A15 | The computer-readable medium of any one of A1-A14, wherein the |
| | operations further comprise: |
| | configuring the kernel with the overall-leading hyperparameter combination; |
| | and |
| | deploying the configured kernel in a machine learning model. |
| B1 | A computer system comprising a processing system and memory, wherein |
| | the processing system comprises one or more processors and a plurality of |
| | accelerators, and wherein the computer system implements an autotuner configured |
| | to perform operations for autotuning accelerator kernel hyperparameters, the |
| | operations comprising: |
| | dividing a set of hyperparameter combinations for an accelerator kernel into |
| | a plurality of batches, wherein a given batch of the plurality of batches comprises a |
| | subset of the set of hyperparameter combinations; |
| | determining respective batch-leading hyperparameter combinations for the |
| | batches and respective performance metrics for the batch-leading hyperparameter |
| | combinations via worker processes performed on respective accelerators of the |
| | plurality of accelerators, wherein determining the batch-leading hyperparameter |
| | combination for the given batch and the performance metric for the batch-leading |
| | hyperparameter combination for the given batch comprises: |
| | evaluating a first plurality of hyperparameter combinations of the |
| | given batch to generate respective performance metrics for the first plurality |
| | of hyperparameter combinations; |
| | configuring an optimization tool with respective performance metrics |
| | for the first plurality of hyperparameter combinations and an indication of a |
| | number of hyperparameter combinations of the given batch to include in a |
| | second plurality of hyperparameter combinations; |
| | triggering the optimization tool to evaluate the second plurality of |
| | hyperparameter combinations to generate respective performance metrics for |
| | the second plurality of hyperparameter combinations and determine the |
| | batch-leading hyperparameter combination for the given batch from among |
| | the first plurality of hyperparameter combinations and the second plurality of |
| | hyperparameter combinations based on the respective performance metrics |
| | for the first plurality of hyperparameter combinations and the second |
| | plurality of hyperparameter combinations, wherein the optimization tool |
| | applies an optimization technique to select the second plurality of |
| | hyperparameter combinations; and |
| | receiving, from the optimization tool, an indication of the batch- |
| | leading hyperparameter combination for the given batch and the performance |
| | metric for the batch-leading hyperparameter combination; |
| | comparing the respective performance metrics for the batch-leading |
| | hyperparameter combinations for the batches to determine an overall-leading |
| | hyperparameter combination from among the batch-leading hyperparameter |
| | combinations; and |
| | outputting the overall-leading hyperparameter combination. |
| B2 | The computer system of B1, wherein the accelerators are Graphics |
| | Processing Units (GPUs), and wherein the accelerator kernel is a GPU kernel. |
| B3 | The computer system of B1 or B2, wherein: |
| | the operations further comprise receiving tuning settings for the accelerator |
| | kernel as inputs to the autotuner; |
| | the tuning settings comprise a known trials setting and an unknown trials |
| | setting; |
| | a number of hyperparameter combinations in the first plurality of |
| | hyperparameter combinations is determined based on a value of the known trials |
| | setting; and |
| | the number of hyperparameter combinations to include in the second |
| | plurality of hyperparameter combinations is determined based on a value of the |
| | unknown trials setting. |
| B4 | The computer system of any one of B1-B3, wherein the hyperparameter |
| | combinations of the first plurality of hyperparameter combinations are randomly |
| | selected valid hyperparameter combinations. |
| C1 | A computer-readable medium having stored thereon computer-executable |
| | instructions for causing a computer system, when programmed thereby, to perform |
| | operations for autotuning accelerator kernel hyperparameters, the operations |
| | comprising: |
| | dividing a set of hyperparameter combinations for an accelerator |
| | kernel into a plurality of batches, wherein a first batch of the plurality of |
| | batches comprises a first subset of the set of hyperparameter combinations |
| | and a second batch of the plurality of batches comprises a second, disjoint |
| | subset of the set of hyperparameter combinations; |
| | determining respective batch-leading hyperparameter combinations |
| | for the batches and respective performance metrics for the batch-leading |
| | hyperparameter combinations, wherein the batch-leading hyperparameter |
| | combinations comprise a first batch-leading hyperparameter combination for |
| | the first batch and a second batch-leading hyperparameter combination for |
| | the second batch, wherein the performance metrics comprise first |
| | performance metrics for the first batch-leading hyperparameter combination |
| | and second performance metrics for the second batch-leading |
| | hyperparameter combination, and wherein the determining comprises: |
| | determining the first batch-leading hyperparameter |
| | combination and the first performance metrics via a first worker |
| | process performed on a first accelerator; and |
| | determining the second batch-leading hyperparameter |
| | combination and the second performance metrics via a second worker |
| | process performed on a second accelerator, wherein the first worker |
| | process and the second worker process are performed in parallel on |
| | the first and second accelerators; |
| | comparing the respective performance metrics for the batch-leading |
| | hyperparameter combinations to determine an overall-leading |
| | hyperparameter combination from among the batch-leading hyperparameter |
| | combinations; and |
| | outputting the overall-leading hyperparameter combination. |

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computer-readable medium having stored thereon computer-executable instructions for causing a computer system, when programmed thereby, to perform operations for autotuning kernel hyperparameters, the operations comprising:
dividing a set of hyperparameter combinations for a kernel into a plurality of batches, wherein a given batch of the plurality of batches comprises a subset of the set of hyperparameter combinations;
determining respective batch-leading hyperparameter combinations for the batches and respective performance metrics for the batch-leading hyperparameter combinations, wherein determining the batch-leading hyperparameter combination for the given batch and the performance metric for the batch-leading hyperparameter combination for the given batch comprises:
evaluating a first plurality of hyperparameter combinations from the given batch to generate respective performance metrics for the first plurality of hyperparameter combinations;
applying an optimization technique to select a second plurality of hyperparameter combinations from the given batch;
evaluating the second plurality of hyperparameter combinations to generate respective performance metrics for the second plurality of hyperparameter combinations; and
determining the batch-leading hyperparameter combination for the given batch from among the first plurality of hyperparameter combinations and the second plurality of hyperparameter combinations based on the respective performance metrics for the first plurality of hyperparameter combinations and the second plurality of hyperparameter combinations;
comparing the respective performance metrics for the batch-leading hyperparameter combinations to determine an overall-leading hyperparameter combination from among the batch-leading hyperparameter combinations; and
outputting the overall-leading hyperparameter combination.

2. The computer-readable medium of claim 1, wherein the set of hyperparameter combinations comprises all possible hyperparameter combinations for the kernel, and wherein the batches collectively comprise all of the possible hyperparameter combinations for the kernel.

3. The computer-readable medium of claim 1, wherein the first plurality of hyperparameter combinations are randomly selected to form an initial sample set, and wherein the operations further comprise, prior to evaluating the first plurality of hyperparameter combinations:
determining that a number of hyperparameter combinations in the initial sample set is less than a predefined initial sample set size;
randomly selecting a given hyperparameter combination from among the hyperparameter combinations of the given batch;
determining that the given hyperparameter combination is valid for the kernel; and
adding the given hyperparameter combination to the initial sample set.

4. The computer-readable medium of claim 1, wherein the optimization technique is selected from the group consisting of Bayesian optimization, grid search, random sampling, Monte Carlo sampling, and brute force search.

5. The computer-readable medium of claim 1, wherein determining the batch-leading hyperparameter combination for the given batch from among the first plurality of hyperparameter combinations and the second plurality of hyperparameter combinations based on the respective performance metrics for the first plurality of hyperparameter combinations and the second plurality of hyperparameter combinations comprises:
determining a subset of valid hyperparameter combinations from among the second plurality of hyperparameter combinations;
comparing the respective performance metrics for the subset of valid hyperparameter combinations and the first plurality of hyperparameter combinations;
determining a most effective hyperparameter combination from among the subset of valid hyperparameter combinations and the first plurality of hyperparameter combinations based on the comparison, wherein the most effective hyperparameter combination provides a best kernel performance among the hyperparameter combinations of the subset of valid hyperparameter combinations and the first plurality of hyperparameter combinations; and
designating the most effective hyperparameter combination as the batch-leading hyperparameter combination for the given batch.

6. The computer-readable medium of claim 1, wherein the operations further comprise receiving a tuning configuration for the kernel, and wherein the tuning configuration comprises respective values for one or more tuning settings.

7. The computer-readable medium of claim 6, wherein:
the tuning settings comprise a known trials setting and an unknown trials setting;
the value of the known trials setting is a first percentage;
the value of the unknown trials setting is a second percentage;
a number of hyperparameter combinations in the first plurality of hyperparameter combinations is determined as the first percentage of a total number of the hyperparameter combinations in the given batch; and
a number of hyperparameter combinations in the second plurality of hyperparameter combinations is determined as the second percentage of the total number of the hyperparameter combinations in the given batch.

8. The computer-readable medium of claim 6, wherein the tuning settings further comprise at least one of the following:
a continue session setting which can be enabled to allow storage of partial tuning results and resumption of a previous tuning session;
a maximum batch size setting with a value that specifies a maximum number of hyperparameter combinations per batch; or
a contender variance setting with a value that specifies a maximum percentage of acceptable variance for performance metrics of contender hyperparameter combinations to corresponding performance metrics of the overall-leading hyperparameter combination.

9. The computer-readable medium of claim 1, wherein determining the respective batch-leading hyperparameter combinations for the batches and the respective performance metrics for the batch-leading hyperparameter combinations comprises:
assigning the batches to respective job queues; and
performing parallel processing of the job queues on respective accelerators.

10. The computer-readable medium of claim 1, wherein determining the batch-leading hyperparameter combination for the given batch and the performance metric for the batch-leading hyperparameter combination comprises:
establishing a kernel cache for the given batch;
generating respective input tensors for the hyperparameter combinations of the given batch; and
generating respective baseline output tensors for the hyperparameter combinations of the given batch.

11. The computer-readable medium of claim 1, wherein the performance metrics comprise at least one of the following:
kernel runtime;
kernel floating-point operations per second during execution; or
kernel throughput.

12. The computer-readable medium of claim 1, wherein evaluating the second plurality of hyperparameter combinations to generate the respective performance metrics for the second plurality of hyperparameter combinations comprises:
validating a given hyperparameter combination of the second plurality of hyperparameter combinations;
determining a performance metric for the given hyperparameter combination;
comparing the performance metric for the given hyperparameter combination to a performance metric for a current batch-leading hyperparameter combination of the given batch;
determining whether a kernel output for the given hyperparameter combination is correct; and
reporting the performance metric for the given hyperparameter combination.

13. The computer-readable medium of claim 1, wherein comparing the respective performance metrics for the batch-leading hyperparameter combinations to determine the overall-leading hyperparameter combination from among the batch-leading hyperparameter combinations comprises:
comparing the respective performance metrics for the batch-leading hyperparameter combinations;
determining a most effective hyperparameter combination from among the batch-leading hyperparameter combinations based on the comparison, wherein the most effective hyperparameter combination provides a best kernel performance among the batch-leading hyperparameter combinations; and
designating the most effective hyperparameter combination as the overall-leading hyperparameter combination.

14. The computer-readable medium of claim 1,
wherein the operations further comprise, after determining the batch-leading hyperparameter combination for the given batch:
designating the hyperparameter combinations of the given batch that are not the batch-leading hyperparameter combination as failed hyperparameter combinations; and
outputting the failed hyperparameter combinations;
wherein comparing the respective performance metrics for the batch-leading hyperparameter combinations to determine the overall-leading hyperparameter combination from among the batch-leading hyperparameter combinations comprises:
determining that the respective performance metrics for one or more of the batch-leading hyperparameter combinations are within a predefined range of the performance metric for the overall-leading hyperparameter combination; and
outputting the one or more of the batch-leading hyperparameter combinations as contender hyperparameter combinations.

15. The computer-readable medium of claim 1, wherein the operations further comprise:
configuring the kernel with the overall-leading hyperparameter combination; and
deploying the configured kernel in a machine learning model.

16. A computer system comprising a processing system and memory, wherein the processing system comprises one or more processors and a plurality of accelerators, and wherein the computer system implements an autotuner configured to perform operations for autotuning accelerator kernel hyperparameters, the operations comprising:
dividing a set of hyperparameter combinations for an accelerator kernel into a plurality of batches, wherein a given batch of the plurality of batches comprises a subset of the set of hyperparameter combinations;
determining respective batch-leading hyperparameter combinations for the batches and respective performance metrics for the batch-leading hyperparameter combinations via worker processes performed on respective accelerators of the plurality of accelerators, wherein determining the batch-leading hyperparameter combination for the given batch and the performance metric for the batch-leading hyperparameter combination for the given batch comprises:
evaluating a first plurality of hyperparameter combinations of the given batch to generate respective performance metrics for the first plurality of hyperparameter combinations;
configuring an optimization tool with respective performance metrics for the first plurality of hyperparameter combinations and an indication of a number of hyperparameter combinations of the given batch to include in a second plurality of hyperparameter combinations;
triggering the optimization tool to evaluate the second plurality of hyperparameter combinations to generate respective performance metrics for the second plurality of hyperparameter combinations and determine the batch-leading hyperparameter combination for the given batch from among the first plurality of hyperparameter combinations and the second plurality of hyperparameter combinations based on the respective performance metrics for the first plurality of hyperparameter combinations and the second plurality of hyperparameter combinations, wherein the optimization tool applies an optimization technique to select the second plurality of hyperparameter combinations; and
receiving, from the optimization tool, an indication of the batch-leading hyperparameter combination for the given batch and the performance metric for the batch-leading hyperparameter combination;
comparing the respective performance metrics for the batch-leading hyperparameter combinations for the batches to determine an overall-leading hyperparameter combination from among the batch-leading hyperparameter combinations; and
outputting the overall-leading hyperparameter combination.

17. The computer system of claim 16, wherein the accelerators are Graphics Processing Units (GPUs), and wherein the accelerator kernel is a GPU kernel.

18. The computer system of claim 16, wherein:
the operations further comprise receiving tuning settings for the accelerator kernel as inputs to the autotuner;
the tuning settings comprise a known trials setting and an unknown trials setting;
a number of hyperparameter combinations in the first plurality of hyperparameter combinations is determined based on a value of the known trials setting; and
the number of hyperparameter combinations to include in the second plurality of hyperparameter combinations is determined based on a value of the unknown trials setting.

19. The computer system of claim 16, wherein the hyperparameter combinations of the first plurality of hyperparameter combinations are randomly selected valid hyperparameter combinations.

20. A computer-readable medium having stored thereon computer-executable instructions for causing a computer system, when programmed thereby, to perform operations for autotuning accelerator kernel hyperparameters, the operations comprising:
dividing a set of hyperparameter combinations for an accelerator kernel into a plurality of batches, wherein a first batch of the plurality of batches comprises a first subset of the set of hyperparameter combinations and a second batch of the plurality of batches comprises a second, disjoint subset of the set of hyperparameter combinations;
determining respective batch-leading hyperparameter combinations for the batches and respective performance metrics for the batch-leading hyperparameter combinations, wherein the batch-leading hyperparameter combinations comprise a first batch-leading hyperparameter combination for the first batch and a second batch-leading hyperparameter combination for the second batch, wherein the performance metrics comprise first performance metrics for the first batch-leading hyperparameter combination and second performance metrics for the second batch-leading hyperparameter combination, and wherein the determining comprises:
determining the first batch-leading hyperparameter combination and the first performance metrics via a first worker process performed on a first accelerator; and
determining the second batch-leading hyperparameter combination and the second performance metrics via a second worker process performed on a second accelerator, wherein the first worker process and the second worker process are performed in parallel on the first and second accelerators;
comparing the respective performance metrics for the batch-leading hyperparameter combinations to determine an overall-leading hyperparameter combination from among the batch-leading hyperparameter combinations; and
outputting the overall-leading hyperparameter combination.
